(19) United States
(12) Patent Application Publication
(10) Pub. No.: US 2026/0104693 A1
(43) Pub. Date: Apr. 16, 2026

(54) SYSTEMS, APPARATUSES, METHODS, AND COMPUTER PROGRAM PRODUCTS FOR SCALABLE AND IMPROVED ASSET PERFORMANCE AND RELIABILITY PREDICTIONS

(71) Applicant: Honeywell International Inc., Charlotte, NC (US)

(72) Inventors: Thangadurai Narayanan, Bengaluru (IN); Prinson Mathew, Bengaluru (IN)

(21) Appl. No.: 18/915,990

(22) Filed: Oct. 15, 2024

(51) Int. Cl. G05B 19/418

(52) U.S. Cl. CPC G05B 19/41875; G05B 19/4185

(57) ABSTRACT

Embodiments of the present disclosure relate to asset monitoring. A plurality of model operations associated with a plurality of assets may be identified. A plurality of model dependency graphs may be generated by applying the plurality of model operations to a graph machine learning model. One or more asset clusters may be generated by applying the plurality of model dependency graphs to a clustering machine learning model. One or more processing groups may be generated based on one or more grouping parameters, each processing group may comprise at least one asset cluster of the one or more asset clusters. Each of the one or more processing groups may be assigned to different processing sub streams of a plurality of processing sub streams such that each processing sub stream is associated with a processing group of the one or more processing groups to facilitate parallel processing.

### TECHNICAL FIELD

The present disclosure relates, generally, to process monitoring and automation systems, and more particularly to systems, apparatuses, methods, and computer program products for scalable and improved asset performance and reliability predictions.

### BACKGROUND

Applicant has discovered problems associated with process monitoring and automation systems. Through applied effort, ingenuity, and innovation, Applicant has solved many of these identified problems by developing solutions embodied in the present disclosure, which are described in detail below.

### BRIEF SUMMARY

Example embodiments provide systems, apparatuses, methods, and computer program products for scalable and improved asset performance and reliability predictions.

In accordance with one aspect of the present disclosure, a computer-implemented method is provided. The computer-implemented method is executable using any of a myriad of computing device(s) and/or combinations of hardware, software, and/or firmware. In some example embodiments, an example computer-implemented method includes identifying, by one or more processors, a plurality of model operations associated with a plurality of assets; generating, by the one or more processors, a plurality of model dependency graphs by applying the plurality of model operations to a graph machine learning model, wherein each model dependency graph comprises a unique subset of the plurality of model operations having a dependency relationship and defines a processing sequence; generating, by the one or more processors, one or more asset clusters by applying the plurality of model dependency graphs to a clustering machine learning model; generating, by the one or more processors and based on one or more grouping parameters, one or more processing groups each comprising at least one asset cluster of the one or more asset clusters; and assigning, by the one or more processors, each of the one or more processing groups to a different processing sub stream of a plurality of processing sub streams such that each processing sub stream is associated with a processing group of the one or more processing groups to facilitate parallel processing.

In some embodiments, the computer-implemented method further includes receiving telemetry data messages associated with the plurality of assets; and routing each of the telemetry data messages to a corresponding processing sub stream of the plurality of processing sub streams based on the processing group associated with each of the telemetry data messages.

In some embodiments, the computer-implemented method further includes processing the plurality of processing sub streams in response to the telemetry data messages routed to each of the plurality of processing sub streams, wherein at least a subset of the plurality of processing sub streams are processed in parallel.

In some embodiments, processing the plurality of processing sub streams comprises processing by a first processor worker of a processor worker set, a first set of telemetry data messages in a first processing sub stream of the plurality of processing sub streams; and processing, by a second processor worker of the processor worker set, a second set of telemetry data messages in a second processing sub stream of the plurality of processing sub streams.

In some embodiments, processing the first set of telemetry data messages comprises identifying a first model dependency graph associated with the first processing sub stream; and executing the unique subset of the plurality of model operations in the first model dependency graph in a sequential order based on the processing sequence defined by the first model dependency graph to generate one or more outputs, wherein executing the unique subset of the plurality of model operations in the first model dependency graph comprises applying telemetry data associated with the first set of telemetry data messages to the plurality of model operations.

In some embodiments, the computer-implemented method further includes initiating performance of one or more asset monitoring and control implementation actions responsive to the one or more outputs being generated.

In some embodiments, the one or more grouping parameters comprises one or more of backfill latency threshold, expected execution frequency, site-specific model operation count, or worker model operation count.

In some embodiments, generating the one or more processing groups comprises determining a maximum number of model operations for each processing sub stream based on the one or more grouping parameters; and performing iterative processing group assignment such that each processing group has a size does not exceed the maximum number of model operations.

In some embodiments, each processing sub stream is associated with a resource consumption throttling mechanism.

In accordance with another aspect of the present disclosure, an apparatus is provided. The apparatus in some embodiments includes at least one processor and at least one non-transitory memory, the at least one non-transitory memory having computer-coded instructions stored thereon. The computer-coded instructions in execution with the at least one processor causes the apparatus to perform any of the example computer-implemented methods described herein. In some other embodiments, the apparatus includes means for performing each step of any of the computer-implemented methods described herein.

In accordance with another aspect of the present disclosure, a computer program product is provided. The computer program product in some embodiments includes at least one non-transitory computer-readable storage medium having computer program code stored thereon. The computer program code in execution with at least one processor is configured for performing any one or the example computer-implemented methods described herein.

### BRIEF DESCRIPTION OF THE SEVERAL VIEWS OF THE DRAWINGS

Having thus described the embodiments of the disclosure in general terms, reference now will be made to the accompanying drawings, which are not necessarily drawn to scale, and wherein:

FIG. 1A illustrates a block diagram of an example system architecture in which embodiments of the present disclosure may operate.

FIG. 1B illustrates a block diagram of an example software platform in accordance with at least some example embodiments of the present disclosure.

FIG. 1C illustrates a block diagram of an example architecture of a model execution engine in accordance with at least some example embodiments of the present disclosure.

FIG. 1D illustrates an example data environment for model execution engine workflow in accordance with at least some example embodiments of the present disclosure.

FIG. 2 illustrates a block diagram of an example apparatus in accordance with at least one example embodiment of the present disclosure.

FIG. 3A each example visualization of data environment for generating asset processing groups in accordance with at least one example embodiment of the present disclosure.

FIG. 3B illustrate example model dependency graphs in accordance with at least some example embodiments of the present disclosure.

FIG. 4 illustrate example processing pipeline in accordance with at least some example embodiments of the present disclosure.

FIG. 5 illustrates a flowchart for generating and assigning processing groups to processing sub streams in accordance with at least some example embodiments of the present disclosure.

FIG. 6 illustrates a flowchart for processing telemetry data messages in accordance with at least some example embodiments of the present disclosure.

### DETAILED DESCRIPTION

Various embodiments of the present disclosure now will be described more fully hereinafter with reference to the accompanying drawings, in which some, but not all, embodiments of the present disclosure are shown. Indeed, the present disclosure may be embodied in many different forms and should not be construed as limited to the embodiments set forth herein, rather, these embodiments are provided so that this disclosure will satisfy applicable legal requirements.

The term “or” is used herein in both the alternative and conjunctive sense, unless otherwise indicated. The terms “illustrative” and “example” are used to be examples with no indication of quality level. Terms such as “computing,” “determining,” “generating,” and/or similar words are used herein interchangeably to refer to the creation, modification, or identification of data. Further, “based on,” “based at least in part on,” “based at least on,” “based upon,” and/or similar words are used herein interchangeably in an open-ended manner such that they do not indicate being based only on or based solely on the referenced element or elements unless so indicated. Like numbers refer to like elements throughout.

### Overview and Technical Improvements

Various embodiments of the present disclosure are generally directed to systems, apparatuses, methods, and computer program products for scalable and improved asset performance and reliability predictions

As would be understood by one skilled in the field to which this disclosure pertains, when one user and/or site data flow volume is increased for several reasons (e.g., restoration of lost communication connectivity, addition of new sites by a user, data being sent in batches, and/or the like) the processing power required for data processing increases significantly and may might limit the processing power available to process other site/user data flow - a scenario that would be understood by one skilled in the field as a noisy neighbor scenario (e.g., causing delays in the processing which affects the monitoring of the assets).

Example embodiments of the present disclosure provides techniques that avoids the noisy neighbor problem and enables the higher throughput in the processing pipeline (e.g., streaming data pipeline) where multiple inter-dependent model operations may be run based on streaming input data. In particular, example embodiments, solve the noisy neighbor problem in multi-tenanted environment such as multi-tenant SaaS solution.

Example embodiments, identify dependency relationships between model operations using a graph machine learning model such as a network graph machine learning model and generates asset clusters automatically. Example embodiments, group the asset clusters into process groups having a maximum number of model operations at which processing performance is not impacted. Example embodiments, map/assign the processing groups shall to a processing sub stream automatically, wherein each processing sub stream represents an independent processing pipeline.

In some embodiments, each processing sub stream includes a throttling mechanism with respect to resource usage and/or number of messages being processed for given interval to ensures that each sub stream has a minimum compute power available. In particular, the throttling mechanism ensures that one or few processing sub streams do not consume the entire compute resources (e.g., processor workers in worker set) which, as would be understood by one skilled in the field to which this disclosure pertains, results in noisy neighbor scenario. In some embodiments, when the number of messages to be processed is high and/or worker resource consumption (CPU, memory) is higher than the configured limit, additional processor worker is provisioned (e.g., spined/scale out) to serve the higher loads.

In this regard, example embodiments of the present disclosure simplify the complexities associated with execution of model operations; solve the noisy neighbor problem in multi-tenanted data processing pipeline for executing model operations; and increases throughput of the processing pipeline by enabling parallel processing of independent model dependency graphs comprising independent sets of model operations. Accordingly, example embodiments of the present disclosure improve various technology and technical fields including data processing technology and asset monitoring and automation systems.

### Definitions

Many modifications and other embodiments of the disclosure set forth herein will come to mind to one skilled in the art to which this disclosure pertains having the benefit of the teachings presented in the foregoing description and the associated drawings. Therefore, it is to be understood that the embodiments are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

As used herein, the term “comprising” means including but not limited to and should be interpreted in the manner it is typically used in the patent context. Use of broader terms such as comprises, includes, and having should be understood to provide support for narrower terms such as consisting of, consisting essentially of, and comprised substantially of.

The phrases “in one embodiment,” “according to one embodiment,” “in some embodiments,” and the like generally mean that the particular feature, structure, or characteristic following the phrase may be included in at least one embodiment of the present disclosure, and may be included in more than one embodiment of the present disclosure (importantly, such phrases do not necessarily refer to the same embodiment).

The word “example” or “exemplary” is used herein to mean “serving as an example, instance, or illustration.” Any implementation described herein as “exemplary” is not necessarily to be construed as preferred or advantageous over other implementations.

If the specification states a component or feature “may,” “can,” “could,” “should,” “would,” “preferably,” “possibly,” “typically,” “optionally,” “for example,” “often,” or “might” (or other such language) be included or have a characteristic, that a specific component or feature is not required to be included or to have the characteristic. Such a component or feature may be optionally included in some embodiments, or it may be excluded.

As used herein, the terms “data,” “content,” “digital content,” “information,” and similar terms may be used interchangeably to refer to data capable of being transmitted, received, and/or stored in accordance with embodiments of the present disclosure. Further, where a computing entity is described herein to receive data from another computing entity, it will be appreciated that the data may be received directly from another computing entity or may be received indirectly via one or more intermediary computing entities, such as, for example, one or more servers, relays, routers, network access points, base stations, hosts, and/or the like, sometimes referred to herein as a “network.” Similarly, where a computing entity is described herein to send data to another computing device, it will be appreciated that the data may be sent directly to another computing entity or may be sent indirectly via one or more intermediary computing devices, such as, for example, one or more servers, relays, routers, network access points, base stations, hosts, and/or the like.

The terms “machine learning module,” “machine learning model,” “ML module(s),” “ML model(s),” artificial intelligence,” or “AI” refer to a machine learning or deep learning task or mechanism. The term “machine learning” refers to a method used to devise complex models and algorithms that lend themselves to prediction. A machine learning model is a computer-implemented algorithm that may learn from data with or without relying on rules-based programming. These models enable reliable, repeatable decisions and results and uncovering of hidden insights through machine-based learning from historical relationships and trends in the data. In some embodiments, the machine learning model is a clustering model, a regression model, a neural network, a random forest, a decision tree model, a classification model, a large language model as defined above, or the like.

A machine learning model may be initially fit or trained on a training dataset (e.g., a set of examples used to fit the parameters of the model). The model may be trained on the training dataset using supervised or unsupervised learning. The model may be run with the training dataset and produce a result, which is then compared with a target, for each input vector in the training dataset. Based on the result of the comparison and the specific learning algorithm being used, the parameters of the model may be adjusted.

The machine learning models as described herein may make use of multiple ML engines (e.g., for analysis, transformation, and other needs). The system may train different artificial intelligence and/or machine learning (AI/ML) models for different needs and different ML-based engines. The system may generate new models (based on the gathered training data) and may evaluate their performance against the existing models. Training data may include any of the gathered information, as well as information on actions performed based on the various recommendations.

The AI/ML models may be any suitable model for the task or activity implemented by each ML-based engine. Machine learning models may be some form of neural network. The underlying AI/ML models may be learning models (supervised or unsupervised). As examples, such algorithms may be prediction (e.g., linear regression) algorithms, classification (e.g., decision trees) algorithms, time-series forecasting (e.g., regression-based) algorithms, association algorithms, clustering algorithms (e.g., K-means clustering, Gaussian mixture models, DBscan), or Bayesian methods (e.g., Naïve Bayes, Bayesian model averaging, Bayesian adaptive trials), image to image models (e.g., FCN, PSPNet, U-Net) sequence to sequence models (e.g., RNNs, LSTMs, BERT, Autoencoders) or Generative models (e.g., GANs).

The AI/ML models may implement statistical algorithms, such as dimensionality reduction, hypothesis testing, one-way analysis of variance (ANOVA) testing, principal component analysis, conjoint analysis, neural networks, support vector machines, decision trees (including random forest methods), ensemble methods, and other techniques. Other ML models may be generative models (such as Generative Adversarial Networks or auto-encoders, generative pre-trained transformer (GPT) model, or the like).

In various embodiments, the AI/ML models may undergo a training or learning phase before they are released into a production or runtime phase or may begin operation with models from existing systems or models. During a training or learning phase, the AI/ML models may be tuned to focus on specific variables, to reduce error margins, or to otherwise optimize their performance. The AI/ML models may initially receive input from a wide variety of data, such as the gathered data described herein. The ML models herein may undergo a second or multiple subsequent training phases for retraining the models.

### Example Systems and Apparatuses of the Disclosure

Embodiments of the present disclosure may be implemented in various ways, including as computer program products that comprise articles of manufacture. Such computer program products may include one or more software components including, for example, software objects, methods, data structures, or the like. A software component may be coded in any of a variety of programming languages. An illustrative programming language may be a lower-level programming language such as an assembly language associated with a particular hardware architecture and/or operating system platform. A software component comprising assembly language instructions may require conversion into executable machine code by an assembler prior to execution by the hardware architecture and/or platform. Another example programming language may be a higher-level programming language that may be portable across multiple architectures. A software component comprising higher-level programming language instructions may require conversion to an intermediate representation by an interpreter or a compiler prior to execution.

Other examples of programming languages include, but are not limited to, a macro language, a shell or command language, a job control language, a script language, a database query or search language, and/or a report writing language. In one or more example embodiments, a software component comprising instructions in one of the foregoing examples of programming languages may be executed directly by an operating system or other software component without having to be first transformed into another form. A software component may be stored as a file or other data storage construct. Software components of a similar type or functionally related may be stored together such as, for example, in a particular directory, folder, or library. Software components may be static (e.g., pre-established, or fixed) or dynamic (e.g., created or modified at the time of execution).

A computer program product may include a non-transitory computer-readable storage medium storing applications, programs, program modules, scripts, source code, program code, object code, byte code, compiled code, interpreted code, machine code, executable instructions, and/or the like (also referred to herein as executable instructions, instructions for execution, computer program products, program code, and/or similar terms used herein interchangeably). Such non-transitory computer-readable storage media include all computer-readable media (including volatile and non-volatile media).

A non-volatile computer-readable storage medium may include a floppy disk, flexible disk, hard disk, solid-state storage (SSS) (e.g., a solid-state drive (SSD), solid-state card (SSC), solid-state module (SSM)), enterprise flash drive, magnetic tape, or any other non-transitory magnetic medium, and/or the like. A non-volatile computer-readable storage medium may also include a punch card, paper tape, optical mark sheet (or any other physical medium with patterns of holes or other optically recognizable indicia), compact disc read only memory (CD-ROM), compact disc-rewritable (CD-RW), digital versatile disc (DVD), Blu-ray disc (BD), any other non-transitory optical medium, and/or the like. Such a non-volatile computer-readable storage medium may also include read-only memory (ROM), programmable read-only memory (PROM), erasable programmable read-only memory (EPROM), electrically erasable programmable read-only memory (EEPROM), flash memory (e.g., Serial, NAND, NOR, and/or the like), multimedia memory cards (MMC), secure digital (SD) memory cards, SmartMedia cards, CompactFlash (CF) cards, Memory Sticks, and/or the like. Further, a non-volatile computer-readable storage medium may also include conductive-bridging random access memory (CBRAM), phase-change random access memory (PRAM), ferroelectric random-access memory (FeRAM), non-volatile random-access memory (NVRAM), magnetoresistive random-access memory (MRAM), resistive random-access memory (RRAM), Silicon-Oxide-Nitride-Oxide-Silicon memory (SONOS), floating junction gate random access memory (FJG RAM), Millipede memory, racetrack memory, and/or the like.

A volatile computer-readable storage medium may include random access memory (RAM), dynamic random access memory (DRAM), static random access memory (SRAM), fast page mode dynamic random access memory (FPM DRAM), extended data-out dynamic random access memory (EDO DRAM), synchronous dynamic random access memory (SDRAM), double data rate synchronous dynamic random access memory (DDR SDRAM), double data rate type two synchronous dynamic random access memory (DDR2 SDRAM), double data rate type three synchronous dynamic random access memory (DDR3 SDRAM), Rambus dynamic random access memory (RDRAM), Twin Transistor RAM (TTRAM), Thyristor RAM (T-RAM), Zero-capacitor (Z-RAM), Rambus in-line memory module (RIMM), dual in-line memory module (DIMM), single in-line memory module (SIMM), video random access memory (VRAM), cache memory (including various levels), flash memory, register memory, and/or the like. It will be appreciated that where embodiments are described to use a computer-readable storage medium, other types of computer-readable storage media may be substituted for or used in addition to the computer-readable storage media described above.

As should be appreciated, various embodiments of the present disclosure may also be implemented as methods, apparatus, systems, computing devices, computing entities, and/or the like. As such, embodiments of the present disclosure may take the form of an apparatus, system, computing device, computing entity, and/or the like executing instructions stored on a computer-readable storage medium to perform certain steps or operations. Thus, embodiments of the present disclosure may also take the form of an entirely hardware embodiment, an entirely computer program product embodiment, and/or an embodiment that comprises a combination of computer program products and hardware performing certain steps or operations.

Embodiments of the present disclosure are described below with reference to block diagrams and flowchart illustrations. Thus, it should be understood that each block of the block diagrams and flowchart illustrations may be implemented in the form of a computer program product, an entirely hardware embodiment, a combination of hardware and computer program products, and/or apparatus, systems, computing devices, computing entities, and/or the like carrying out instructions, operations, steps, and similar words used interchangeably (e.g., the executable instructions, instructions for execution, program code, and/or the like) on a computer-readable storage medium for execution. For example, retrieval, loading, and execution of code may be performed sequentially such that one instruction is retrieved, loaded, and executed at a time. In some example embodiments, retrieval, loading, and/or execution may be performed in parallel such that multiple instructions are retrieved, loaded, and/or executed together. Thus, such embodiments may produce specifically configured machines performing the steps or operations specified in the block diagrams and flowchart illustrations. Accordingly, the block diagrams and flowchart illustrations support various combinations of embodiments for performing the specified instructions, operations, or steps.

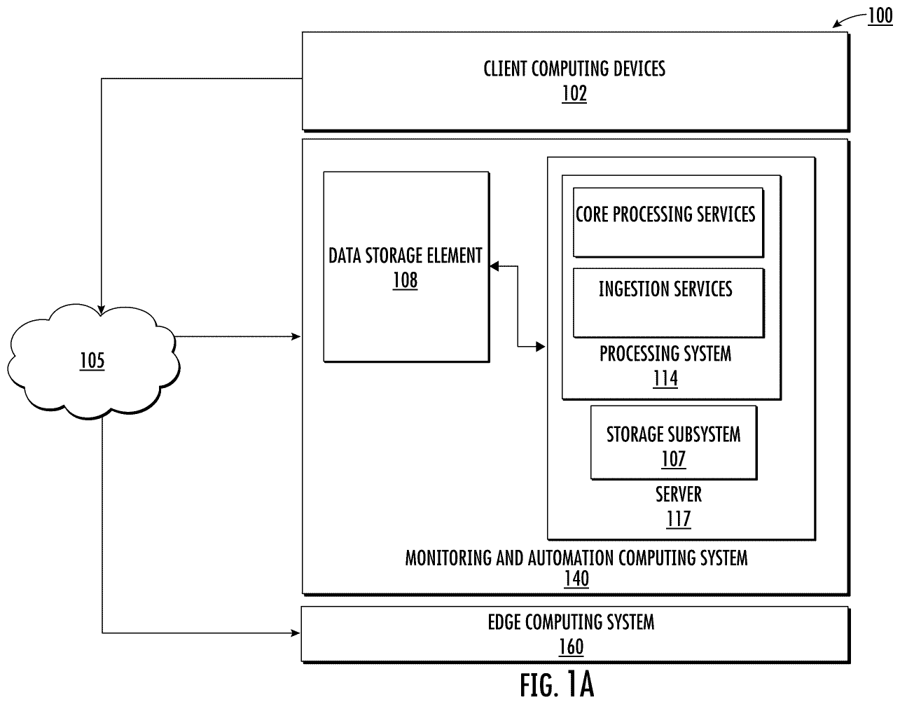

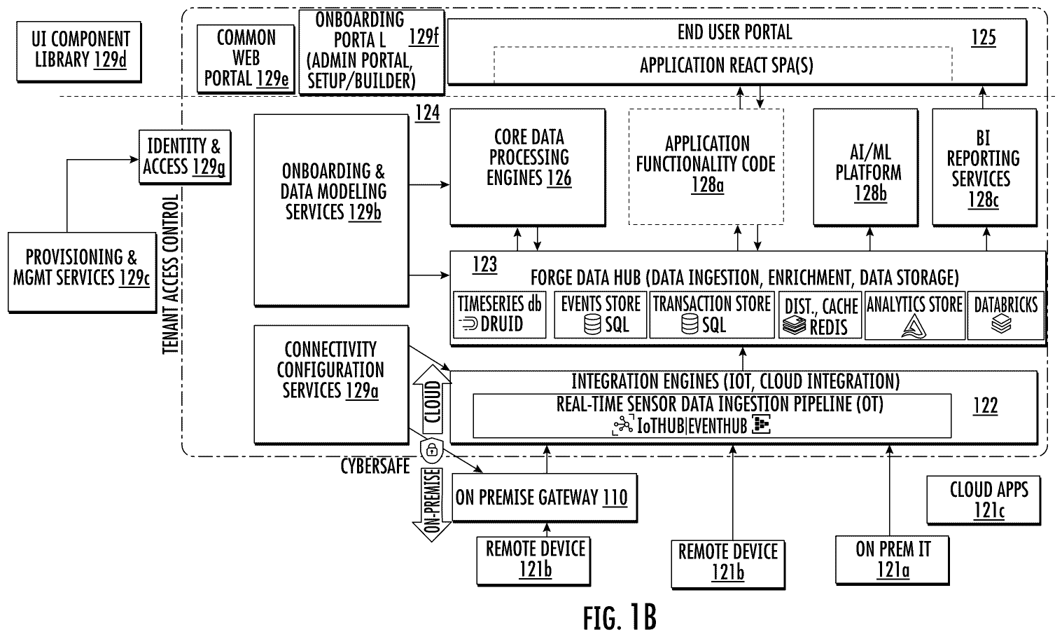

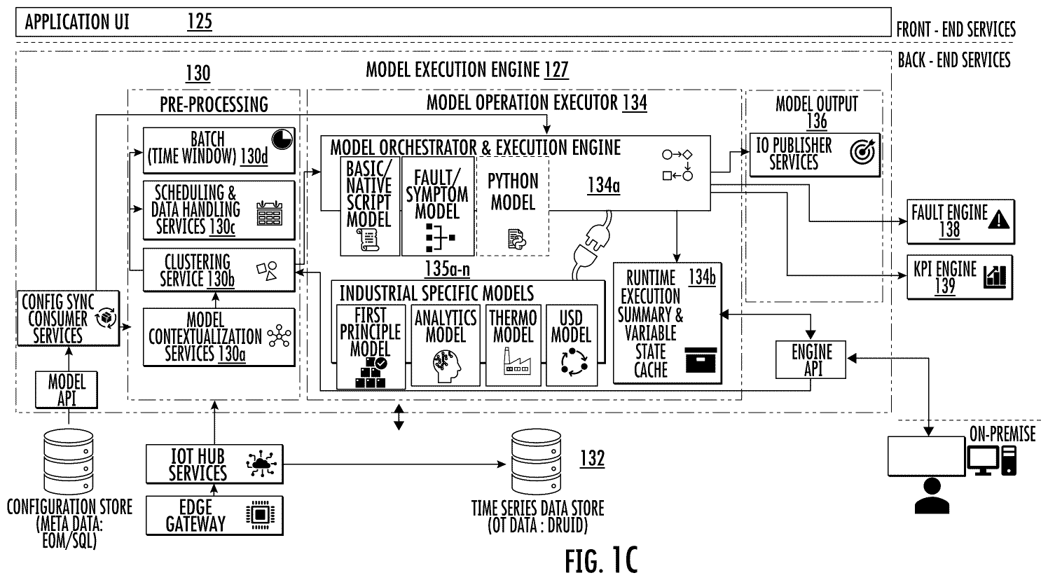

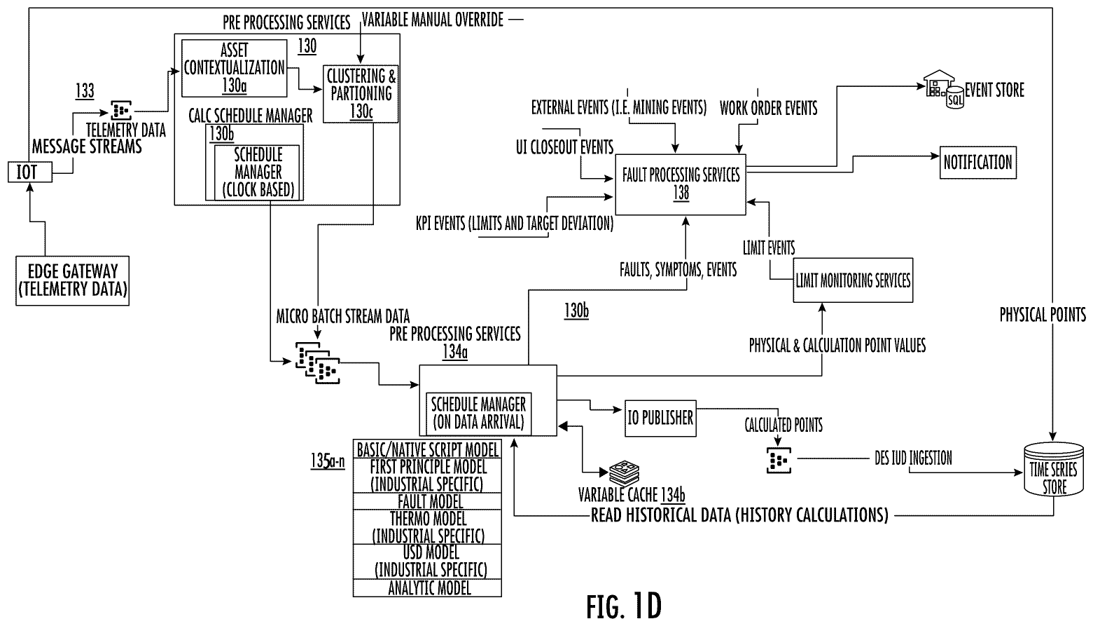

In this regard, FIG. 1A provides an example overview of a system architecture 100 in accordance with at least some example embodiments of the present disclosure. The depiction of the example architecture 100 is not intended to limit or otherwise confine the embodiments described and contemplated herein to any particular configuration of elements or systems, nor is it intended to exclude any alternative configurations or systems for the set of configurations and systems that can be used in connection with embodiments of the present disclosure. Rather, FIG. 1A and the architecture 100 disclosed therein is merely presented to provide an example basis and context for the facilitation of some of the features, aspects, and uses of the methods, apparatuses, computer readable media, and computer program products disclosed and contemplated herein. It will be understood that while many of the aspects and components presented in FIG. 1A are shown as discrete, separate elements, other configurations may be used in connection with the methods, apparatuses, computer readable media, and computer programs described herein, including configurations that combine, omit, separate, and/or add aspects and/or components. The example system architecture 100 may be used in a plurality of domains and not limited to any specific application as disclosed herewith. In particular, while some example embodiments are described herein with reference to particular domain, the example system architecture 100 may be used in a plurality of domains and limited to any specific application as disclosed herein. The plurality of domains may include healthcare, industrial, manufacturing, education, retail, to name a few.

As illustrated, the system architecture 100 includes a monitoring and automation computing system 140 configured to receive data from edge computing systems 160, process the data to generate outputs, and initiate performance of one or more asset monitoring and control implementation actions, including providing the outputs to client computing devices 102. In various embodiments, such outputs may include model outputs for one or more assets associated with a site (also referred to herein as tenant site). Non-limiting examples of such model outputs include one or more items of data representative and/or indicative of a state of one or more assets; one or more items of data representative and/or indicative of reconfiguration data for reconfiguration one or more asset; one or more items of data representative and/or indicative of one or more abnormal conditions for one or more assets; one or more items of data representative and/or indicative of one or more detected faults for one or more assets; one or more items of data representative and/or indicative of one or more predicted faults for one or more assets; and/or one or more items of data representative and/or indicative of one or more performance indicators (e.g., key performance indicators (KPI)) for one or more assets; one or more items of data representative and/or indicative of one or more root causes for abnormal conditions and/or identified faults (e.g., detected faults, and/or predicted faults) for one or more assets; one or more items of data representative and/or indicative of one or more corrective actions for resolving abnormal conditions and/or identified faults for one or more assets; and/or other data that may be used for effective monitoring, control, and/or automation of asset(s) associated with a site.

In some embodiments, an asset may be a machine, a tank, a pipe, a pump, an HVAC, bearing of pump, a valve, a controller, an electric device, equipment, or any other physical structure or object within or associated with a processing plant that is utilized in or in support of a process performed by the processing plant. In some embodiments, a processing plant, industrial plant, plant, and/or similar terms used herein interchangeably may refer to one or more buildings, complex, or arrangement of components that perform operation(s)/processes (e.g., a chemical, physical, electrical, mechanical process, and/or the like) for converting input materials into one or more output products. Non-limiting examples of a processing plant include a chemical industrial plant, automotive manufacturing plant, distillery, oil refinery, fabric manufacturing plant, and/or the like. In various embodiments, a site represents or otherwise comprises a process plant, a processing plant, industrial plant, plant, and/or similar terms used herein interchangeably

In various embodiments, the monitoring and automation computing system 140 is communicatively coupled to the edge computing systems 160 and is configured to support any number of edge computing systems 160, which may be of different configurations. In various embodiments, the monitoring and automation computing system 140 is a cloud-based monitoring and automation computing system 140. The monitoring and automation computing system 140 may communicate with the edge computing systems 160 using one or more communication networks, for example a communications network 105.

It should be appreciated that the communications network 105 in some embodiments is embodied in any of a myriad of network configurations. In some embodiments, the communications network 105 embodies a public network (e.g., the Internet). In some embodiments, the communications network 105 embodies a private network (e.g., an internal localized, or closed-off network between particular devices). In some other embodiments, the communications network 105 embodies a hybrid network (e.g., a network enabling internal communications between particular connected devices and external communications with other devices). The communications network 105 in some embodiments includes one or more base station(s), relay(s), router(s), switch(es), cell tower(s), communications cable(s) and/or associated routing station(s), and/or the like. In some embodiments, the communications network 105 includes one or more user-controlled computing device(s) (e.g., a user owned router and/or modem) and/or one or more external utility devices (e.g., Internet service provider communication tower(s) and/or other device(s)).

Each of the components of the system architecture 100 may be communicatively coupled to transmit data to and/or receive data from one another over the same or different wireless and/or wired networks embodying the communications network 105. Such configuration(s) include, without limitation, a wired or wireless Personal Area Network (PAN), Local Area Network (LAN), Metropolitan Area Network (MAN), Wide Area Network (WAN), and/or the like. Additionally, while FIG. 1A illustrate certain system entities as separate, standalone entities communicating over the communications network 105, the various embodiments are not limited to this architecture. In other embodiments, one or more computing entities share one or more components, hardware, and/or the like, or otherwise are embodied by a single computing device such that connection(s) between the computing entities are over the communications network 105 are altered and/or rendered unnecessary.

In general, the terms device, system, computing entity, entity, and/or similar words used herein interchangeably may refer to, for example, one or more computers, computing entities, desktops, mobile phones, tablets, phablets, notebooks, laptops, distributed systems, kiosks, input terminals, servers or server networks, blades, gateways, switches, processing devices, processing entities, set-top boxes, relays, routers, network access points, base stations, the like, and/or any combination of devices or entities adapted to perform the functions, operations, and/or processes described herein.

The edge computing system(s) 160 may be located at any number of sites (e.g., manufacturing plants, industrial plants, warehouses, distribution centers, and/or the like), which may be associated with any number of tenants (e.g., enterprise, organization, and/or similar terms) in a multi-tenant implementation or associated with a single tenant in a single-tenant implementation.

In some embodiments, a client computing device 102 may include an antenna, a transmitter (e.g., radio), a receiver (e.g., radio), and a processing element (e.g., CPLDs, microprocessors, multi-core processors, coprocessing entities, ASIPs, microcontrollers, and/or controllers) that provides signals to and receives signals from the transmitter and receiver, correspondingly. The client computing device 102 may also comprise a user interface (that may include an output device (e.g., display, speaker, tactile instrument, etc.) coupled to a processing element) and/or a user input interface (coupled to a processing element). For example, the user interface may be a user application, browser, user interface, and/or similar words used herein interchangeably executing on and/or accessible via the client computing device 102 to interact with and/or cause display of information/data from another computing entity, as described herein. The user input interface may comprise any of a plurality of input devices (or interfaces) allowing the client computing device 102 to receive code and/or data, such as a keypad (hard or soft), a touch display, voice/speech or motion interfaces, or other input device. The client computing device 102 may also include volatile memory and/or non-volatile memory, which may be embedded and/or may be removable.

As described above, the monitoring and automation computing system 140 is configured to receive telemetry data from edge computing systems 160 and process the telemetry data to generate outputs. In various embodiments, receiving telemetry data from edge computing systems 160 comprises receiving telemetry data messages comprising telemetry data and/or other data from the edge computing systems 160 over a communications network, such as communications network 105. In various embodiments, the monitoring and automation computing system 140 maintains the received telemetry data in one or more storage subsystems 107 (e.g., memory 107).

In various embodiments, the monitoring and automation computing system 140 is configured to process the telemetry data messages (e.g., including the telemetry data thereof) associated with one or more assets or otherwise associated with a site comprising (or otherwise associated with the one or more assets) to generate model outputs for the one or more assets. For example, the monitoring and automation computing system 140 may be configured to receive, for each of one or more sites (e.g., tenant sites), telemetry data for one or more assets associated with the respective site for monitoring, controlling, and/or automating one or more processes associated with the respective site. The monitoring and automation computing system 140 may be configured to process the telemetry data messages for the respective tenants to generate one or more outputs (as described above) for at least a portion of the one or more assets associated with the respective site. In various embodiments, processing telemetry data messages comprises applying the telemetry data (e.g., included and/or extracted from the telemetry data messages) to one or more asset monitoring models (also referred to herein as “model”) configured to generate the model outputs. The one or more asset monitoring models may comprise a number of different models such as, for example, basic script model (e.g., native script model), fault symptom models, python models, first principles models, analytics model, thermos models, empirical models, mathematical models, machine learning models, rules-based models, Unisim Design Simulation (USD) models, and/or other models. In various embodiments, each of the one or more asset monitoring models defines or otherwise comprises one or more model operations. In various embodiments, the one or more model operations defined by an asset monitoring model may include one or more calculations, algorithms, functions, rules, and/or the like used herein interchangeably.

In some embodiments and as illustrated in the system architecture 100, the monitoring and automation computing system 140 may include one or more servers 117 that are communicatively coupled to one or more data storage elements 108 configured to support operation of the monitoring and automation computing system 140.

A server 117 may represents or otherwise comprise a server computing device or system that includes at least one processing system 114 comprising hardware, software, firmware and/or combination thereof configured to support operation of the server 117. In various embodiments, the processing system 114 comprises a processor, an application specific integrated circuit (ASIC), a field programmable gate array (FPGA) and/or other programmable logic device, discrete gate or transistor logic, discrete hardware components, or any combination thereof configured to support and/or perform various functions associated the monitoring and automation computing system 140.

The processing system 114 may include and/or access the data storage element 108. In some embodiments, the data storage element 108 may be implemented as or otherwise comprise any non-transitory storage media configured for storing programming instructions for execution by the processing system 114 to support, facilitate, and/or perform one or more tasks, operations, and/or processes described herein. It would be appreciated that while FIG. 1A depicts the data storage elements 108 being part of the monitoring and automation computing system 140 as the server 117, the data storage elements 108 may be implemented or otherwise associated with another computing system (e.g., another cloud-based computing system) that is external or otherwise separate from the monitoring and automation computing system 140).

In various embodiments, the monitoring and automation computing system 140 includes one or more components that form a software platform 120 that includes various components (e.g., processes, services, microservices, modules, engines, software, databases, computing devices, processors, memory, models, hardware, firmware, and/or the like) that are configured to support the tasks, operations, and/or processes described herein, including various functionalities of the monitoring and automation computing system 140 described herein. For example, the monitoring and automation computing system 140 may represent or otherwise comprise a software platform 120. In some examples, the computer-executable programming instructions stored by the data storage element 108 may be executed by the processing system 114 to generate, execute, or otherwise implement the software platform 120.

In various embodiments, the software platform 120 represent a platform capable of connecting any type of internet-connected device, including IoT devices. In this regard, the software platform 120 may represent or otherwise may be referred to herein interchangeably as an IoT platform 120.

FIG. 1B depicts an example software platform 120 in accordance with at least some example embodiments of the present disclosure. The software platform 120 may include a number of layers, including, for example, an integration layer 122, a data management layer 123, a data pipeline layer 124, and/or an interface services layer 125. Each layer 122-125 may include various components, including software components, that together form the respective layer. For example, a layer 122-125 may include one or more modules, models, engines, databases, services, applications, combination thereof, and/or the like. In some embodiments, the layers 122-125 may be combined to form fewer layers. In some embodiments, some of the layers 122-125 may be separated into separate layers such that the software platform 120 includes additional layers. In some embodiments, some of the layers 122-125 may be removed while other layers may be added.

The integration layer 122 may include one or more components for events and/or messaging, file upload, and/or the like. In various embodiments, the components of the integration layer 122 are configured to enable data to be ingested into or otherwise received at the software platform 120 from a variety of sources. The components of the integration layer may be configured to enable the software platform 120 to communicate with third-party applications such as cloud applications and/or communicate with edge devices (e.g., remote devices or on premises devices) which may be operated by or otherwise associated with users of the software platform 120 and/or monitoring and automation computing system 140. In this regards, such users of the monitoring and automation computing system 140 may be referred to herein as tenants (e.g., enterprise, organization, and/or the like). The integration layer 122 may be configured to connect with edge devices, databases, and/or other data sources associated with a user (e.g., a tenant). In some embodiments, the integration layer 122 may provide application programming interfaces (APIs) to users for accessing the software platform 120.

The data management layer 123 may include one or more components for device management, data ingestion, control, storage and/or maintenance of data received via edge devices and/or cloud applications. In various the edge devices and/or cloud applications may be associated with an edge computing system 160 as described herein. In various embodiments, the components of the data management layer 123 are configured to enable data to be ingested into or otherwise received at the software platform 120 from a variety of sources. In some embodiments, the data management layer 123 includes one or more components for data preprocessing such as data cleansing, data enrichment, data transformation, data contextualization, and/or the like. The data management layer 123 may include one or more data storage components such as time series databases, event stores, transactions stores, distribution data store, analytics data stores, data bricks, relational databases, data lakes, and/or the like. For example, the data management layer 123 may include one or more components for timeseries databases, such that when data (e.g., telemetry data, or other data) is received at the IoT platform 120, the data can be stored as timeseries tags or events to support further processing. In various embodiments, the data management layer 123 includes one or more data ingestions services configured to receive telemetry data 133 originating from edge computing system 160 over the communications network 105 and store the received telemetry data 133 to the one or more data storage elements 108. In this regard, the one or more data storage elements 108 include one or more time series databases, data lake databases, or any other suitable data repository. In this regard, the one or more data storage elements 108 include one or more time series databases, data lake databases, or any other suitable data repository. Alternatively or additionally, in various embodiments, one or more data ingestion services may be configured to receive telemetry data 133 originating from edge computing system 160 over the communications network 105 and provide the received telemetry data 133 to the pre-processing module, such as pre-processing module 130 described further below.

The data pipeline layer 124 may include one or more components for providing various services including analytics that supports monitoring, control, and/or automation of one or more assets and/or processes associated with a site (e.g., a process plant, industrial plant, manufacturing plant, and/or the like as described herein). For example the data pipeline layer 124 may process and/or perform analytics on received data (e.g., telemetry data and/or other data) associated with one or more assets associated with a site. The data pipeline layer 124 may include or otherwise leverage one or more models that define one or more model operations. In various embodiments, the data pipeline layer 124 includes core data processing engine 126 configured to support or otherwise execute the one or more models based on telemetry data 133 received from an edge computing system 160 (e.g., form one or more edge devices or cloud apps thereof to generate outputs associated with one or more assets, as described herein. In this regard, such one or more models may be referred to herein as asset monitoring models. The software platform 120 may be configured to support a variety of different asset monitoring models, including for example first principles models, mathematical models, rules-based models, empirical models, user-defined models, machine learning models, analytical models, mathematical models, fault symptom models, predictive maintenance models, and/or the like. In some embodiments, the data pipeline layer 124 may further include application services 128a such as one or more components for rules engines, workflow, notifications, and/or the like. As illustrated in FIG. 1B, the software platform 120 may include other components such as AI/ML platform 128b, BI/reporting services 128c, connectivity configuration services 129a, onboarding and data modeling services 129b, provisioning and management services 129c, user interface (UI) component library 129d, web portal 129e, onboarding portal 129f, and/or security services 129g (e.g., identify and access services).

Referencing FIG. 1C (which depicts an example architecture of a model execution engine 127 in accordance with at least some example embodiments of the present disclosure) and FIG. 1D (which depicts an example data environment for model execution engine workflow in accordance with various embodiments of the present disclosure), the core data processing engine 126 includes a model execution engine 127. In the illustrated example in FIG. 1C, the model execution engine 127 includes a pre-processing module 130 comprising a model contextualization service 130a, clustering service 130b, scheduling and data handling services 130c, and/or batch services 130d.

The model execution engine 127 further includes model operation executor module 134 configured to receive telemetry data messages (comprising telemetry data) from clustering services. Such telemetry data messages may be contextualized. For example, the telemetry data messages may comprise contextualized telemetry data. As shown in FIG. 1C, the model operation executor module 134 includes a model orchestrator and execution engine 134a configured to execute one or more asset monitoring models 135a-n based on telemetry data (which may be contextualized telemetry data in some examples) received from the clustering service 130b.

For example, the model orchestrator and execution engine 134a may be configured to analyze and/or process telemetry data 133 received via the edge computing system 160 and preprocessed at the preprocessing module (in some examples) and/or maintained in the data storage elements 108 associated with the monitoring and automation computing system 140 (in some examples) to support analytics, reporting, and/or other analysis with respect to the telemetry data and associated asset(s). As described, further below, in various embodiments, the clustering service 130b is configured to route the telemetry data 133 associated with a user identifier (e.g., site identifier) to corresponding processing sub streams (representing independent processing pipelines) pre-assigned to the user identifier, wherein each processing sub stream is associated with a processor worker set for processing the telemetry data messages.

In some embodiments, the model operation executor module 134 may further include a storage cache 134b for storing runtime data such as, for example, runtime execution summary and variable state data.

The model execution engine 127 may further include an output module 136 configured to publish or otherwise provide output (e.g., model output) generated at the model operation executor module 134. For example, the model operation executor module 134 may be configured to provide the output obtained responsive to execution of the one or more models 135a-n to one or more client computing devices 102, to a fault engine 138 associated with the software platform 120 and/or monitoring and automation computing system 140, and/or to a performance engine 139 (e.g., KPI engine) associated with the software platform 120 and/or monitoring and automation computing system 140. The fault engine 138 and the performance engine 139 may represent and/or provide fault processing services and performance processing services, respectively. In particular, in some embodiments, the monitoring and automation computing system 140, using the fault engine 138 and/or performance engine 139 may be configured to initiate performance of one or more asset monitoring and control implementation actions based on the model outputs.

The interface services layer 125 may incudes one or more components for providing front-end services such as data visualization, user portal, and/or the like. For example, the interface services layer 125 may provide corresponding user interface displays, such as graphical user interface (GUI) displays, model outputs, reports, alerts, and/or or other user notifications, via client computing devices 102 (e.g., client computing devices) communicatively coupled to the monitoring and automation computing system 140. In this regard, the client computing devices 102 may be any mobile computing device, smartphone, laptop, tablet, personal computer or other network-enabled electronic device that includes any electronic display device capable of presenting (e.g., graphically presenting) data and/or information along with one or more user input devices capable of receiving input from the user of the client computing device 102. In some embodiments, a client computing device 102 may include a processing system that includes or is otherwise coupled to a data storage element 108 having programming instructions or code that, when read and executed, cause the processing system to generate or otherwise facilitate a web browser or other client-side application on the client computing device 102 that supports interaction with the interface services layer 125 at the software platform 120 to present the user interface displays, model outputs, reports, alerts, or other notifications generated by the interface services layer 125 within the client-side application at the client computing device 102.

Referencing FIG. 1A and FIG. 1B, an edge computing system 160 may represent or otherwise comprise one or more devices 121a co-located at a common site/on premises, one or more devices 121b co-located at a common site/on premises or remote to support or otherwise provide asset monitoring and automation, and/or one or more cloud applications 121c. Such device(s) may include one or more measurement devices, one or more actuators, and/or one or more controllers that are communicatively coupled to the monitoring and automation computing system 140 over communications network 105 at the edge computing system 160. In some embodiments, one or more of the devices (e.g., one or more measurement devices, one or more actuators, and/or one or more controllers) may be communicatively coupled to the monitoring and automation computing system 140 over communications network 105 via a gateway device 110 at the edge computing system 160.

In various embodiments, the measurement devices represent or otherwise comprise sensors or other measurement devices deployed at or otherwise associated with the site associated with the edge computing system 160 to provide telemetry data or other measurement data by sensing, measuring, detecting or otherwise quantifying a characteristic or condition associated with one or more assets and/or processes at the site. A process, for example, may comprise one or more assets that work together to generate a process output. In this regard, the measurement devices may provide telemetry data or other measurement data comprising one or more items of data representative and/or indicative of characteristics or conditions associated with one or more assets at a given site.

Non-limiting examples of such characteristics or conditions include environmental condition (e.g., current temperature, humidity, or the like) and/or operational condition (e.g., current fluid properties for each of one or more pumps, such as temperature, density, viscosity, and/or the like; current pump flow rate, current pump pressure, current state or configuration of a bearing, and/or other the like). It would be appreciated that any number of different measurement devices may be deployed and configured in a manner that will vary to obtain a variety of different types of telemetry data, depending on the particular asset(s), site(s), processes, and/or user (e.g., tenant) and is not limited to any particular type of configuration of measurement devices.

In various embodiments, an actuator represent or otherwise comprise mechanical, electrical, magnetic, electromagnetic, pneumatic, hydraulic, and/or the like, which may influence a characteristic or condition associated with an asset, such as, for example, environmental conditions or operational conditions that are sensed or quantified by the measurement devices. For example, an actuator may be configured to operate a valve which influences a fluid flow or pressure measured by a measurement device. It would be appreciated that any number of different actuators may be deployed and configured in a manner that will vary depending on the particular asset(s), site(s), process, and/or user, and is not limited to any particular type of configuration of actuators. In various embodiments, a controller represent or otherwise comprise hardware, firmware, and/or software components or devices associated with the edge computing system 160 that support control of one or more processes and/or one or more assets at the associated site.

In various embodiments, a gateway device 110 represents or otherwise comprise hardware, firmware, and/or software associated with one more network interfaces that are connected to the communications network 105 and one or more of the other edge devices 121a-c to support and/or facilitate data transfer between the one or more of the other edge devices 121a-c, and the software platform 120. For example, the gateway device 110 may include an ethernet networking interface, a wireless transceiver, a cellular transceiver, or other suitable combination of hardware, firmware, and/or software to support communications to and/or from the communications network 105. Additionally, the gateway device 110 may include one or more additional ethernet networking interfaces, wireless transceivers, network interface cards, or the like to support communications with edge devices 121a-c at the edge computing system 160. For example, in some implementations, the gateway device 110 is coupled to the various edge devices using ethernet or another wired LAN, wireless LAN, a pneumatic control network, or any other network suitable for supporting IoT devices at the edge computing system 160, where the edge devices 121a-c communicating on the network associated with the edge computing system 160 are unable to communicate over the communications network 105 independent of the gateway device 110.

In various embodiments, the gateway device 110 includes or accesses one or more buffers or other suitable data storage for storing and maintaining telemetry data from the edge devices 121a-c, including, but not limited to, measurement data provided by the measurement devices, actuation state data provided by the actuators, and/or control data provided by the controllers. In some embodiments, in response to a loss of connectively between the gateway device 110 and the software platform 120, a telemetry data streaming service or other telemetry data transfer service associated with the gateway device 110 is configured to store or otherwise maintain telemetry data provided by the various edge devices 121a-c in the one or more buffers until connectivity is restored. In response to detecting an available communication connection between the gateway device 110 and the software platform 120 and/or network 105, the telemetry data streaming service or other telemetry data transfer service associated with the gateway device 110 may be configured to automatically upload or otherwise transmit any backlogged telemetry data from the one or more buffers to the software platform 120 (e.g., integration layer 122 and/or data management layer 123 thereof). In this regard, in some example implementations, the gateway device 110 may utilize the backlogged telemetry data in the one or more buffers to generate a stream of telemetry data messages that are streamed, uploaded, or otherwise transmitted to the software platform 120 automatically in response to re-establishment of communication connection with the software platform 120, which may result in a surge or increased volume of telemetry data messages to be ingested at the software platform 120 for processing by the model execution engine 127 of the software platform 120 to generate model output(s) as described herein.

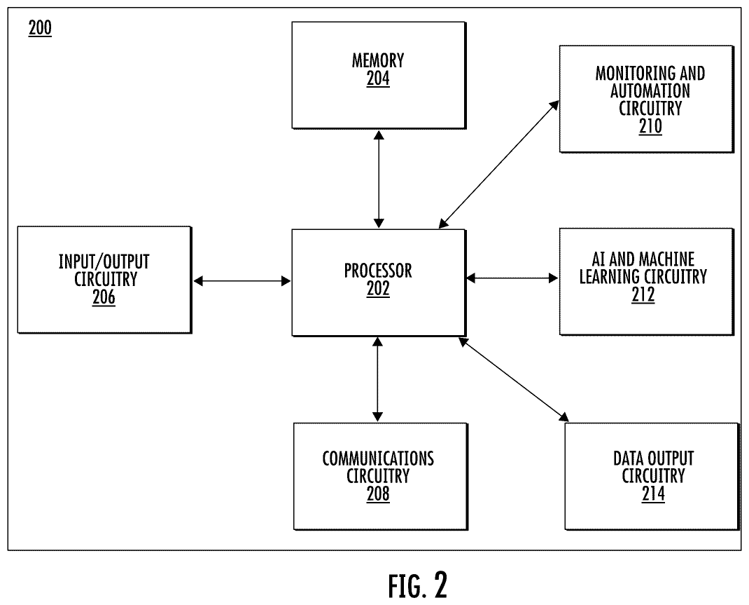

FIG. 2 illustrates a block diagram of an example apparatus that may be specially configured in accordance with at least one example embodiment of the present disclosure. Specifically, FIG. 2 depicts an example monitoring and automation apparatus 200 (“apparatus 200”) specially configured in accordance with at least some example embodiments of the present disclosure. In some embodiments, the system 140 and/or a portion thereof is embodied by one or more system(s), such as the apparatus 200 as depicted and described in FIG. 2. The apparatus 200 includes processor 202, memory 204, input/output circuitry 206, communications circuitry 208, monitoring and automation circuitry 210, AI and machine learning circuitry 212, and/or data output circuitry 214. In some embodiments, the apparatus 200 is configured, using one or more of the sets of circuitry embodied by processor 202, memory 204, input/output circuitry 206, communications circuitry 208, monitoring and automation circuitry 210, AI and machine learning circuitry 212, and/or data output circuitry 214 to execute and perform the operations described herein.

In general, the terms computing entity (or “entity” in reference other than to a user), device, system, and/or similar words used herein interchangeably may refer to, for example, one or more computers, computing entities, desktop computers, mobile phones, tablets, phablets, notebooks, laptops, distributed systems, items/devices, terminals, servers or server networks, blades, gateways, switches, processing devices, processing entities, set-top boxes, relays, routers, network access points, base stations, the like, and/or any combination of devices or entities adapted to perform the functions, operations, and/or processes described herein. Such functions, operations, and/or processes may include, for example, transmitting, receiving, operating on, processing, displaying, storing, determining, creating/generating, monitoring, evaluating, comparing, and/or similar terms used herein interchangeably. In one embodiment, these functions, operations, and/or processes can be performed on data, content, information, and/or similar terms used herein interchangeably. In this regard, the apparatus 200 embodies a particular, specially configured computing entity transformed to enable the specific operations described herein and provide the specific advantages associated therewith, as described herein.

Although components are described with respect to functional limitations, it should be understood that the particular implementations necessarily include the use of particular computing hardware. It should also be understood that in some embodiments certain of the components described herein include similar or common hardware. For example, in some embodiments two sets of circuitry both leverage use of the same processor(s), network interface(s), storage medium(s), and/or the like, to perform their associated functions, such that duplicate hardware is not required for each set of circuitry. In some examples, “circuitry” as used herein with respect to components of the apparatuses described herein include particular hardware, software, or combination of hardware and software configured to perform the functions associated with the particular circuitry as described herein.

Particularly, the term “circuitry” should be understood broadly to include hardware only, software only, or a combination of hardware and software. In some embodiments, “circuitry” includes processing circuitry, storage media, network interfaces, input/output devices, and/or the like. Alternatively or additionally, in some embodiments, other elements of the apparatus 200 provide or supplement the functionality of another particular set of circuitry. For example, the processor 202 in some embodiments provides processing functionality to any of the sets of circuitry, the memory 204 provides storage functionality to any of the sets of circuitry, the communications circuitry 208 provides network interface functionality to any of the sets of circuitry, and/or the like.

In some embodiments, the processor 202 (and/or co-processor or any other processing circuitry assisting or otherwise associated with the processor) is/are in communication with the memory 204 via a bus for passing information among components of the apparatus 200. In some embodiments, for example, the memory 204 is non-transitory and may include, for example, one or more volatile and/or non-volatile memories. In other words, for example, the memory 204 in some embodiments includes or embodies an electronic storage device (e.g., a computer readable storage medium). In some embodiments, the memory 204 is configured to store information, data, content, applications, instructions, or the like, for enabling the apparatus 200 to carry out various functions in accordance with example embodiments of the present disclosure.

The processor 202 may be embodied in a number of different ways. For example, in some example embodiments, the processor 202 includes one or more processing devices configured to perform independently. Additionally or alternatively, in some embodiments, the processor 202 includes one or more processor(s) configured in tandem via a bus to enable independent execution of instructions, pipelining, and/or multithreading. The use of the terms “processor” and “processing circuitry” should be understood to include a single core processor, a multi-core processor, multiple processors internal to the apparatus 200, and/or one or more remote or “cloud” processor(s) external to the apparatus 200.

In an example embodiment, the processor 202 is configured to execute instructions stored in the memory 204 or otherwise accessible to the processor. Alternatively or additionally, the processor 202 in some embodiments is configured to execute hard-coded functionality. As such, whether configured by hardware or software methods, or by a combination thereof, the processor 202 represents an entity (e.g., physically embodied in circuitry) capable of performing operations according to an embodiment of the present disclosure while configured accordingly. Alternatively or additionally, as another example in some example embodiments, when the processor 202 is embodied as an executor of software instructions, the instructions specifically configure the processor 202 to perform the algorithms embodied in the specific operations described herein when such instructions are executed. As one particular example embodiment, the processor 202 is configured to perform various operations associated with the computing system 140.

In some embodiments, the apparatus 200 includes input/output circuitry 206 that provides output to the user and, in some embodiments, to receive an indication of a user input. In some embodiments, the input/output circuitry 206 is in communication with the processor 202 to provide such functionality. The input/output circuitry 206 may comprise one or more user interface(s) and in some embodiments includes a display that comprises the interface(s) rendered as a web user interface, an application user interface, a user device, a backend system, or the like. In some embodiments, the input/output circuitry 206 also includes a keyboard, a mouse, a joystick, a touch screen, touch areas, soft keys a microphone, a speaker, or other input/output mechanisms. The processor 202 and/or input/output circuitry 206 comprising the processor may be configured to control one or more functions of one or more user interface elements through computer program instructions (e.g., software and/or firmware) stored on a memory accessible to the processor (e.g., memory 204, and/or the like). In some embodiments, the input/output circuitry 206 includes or utilizes a user-facing application to provide input/output functionality to a client device and/or other display associated with a user.

In some embodiments, the apparatus 200 includes communications circuitry 208. The communications circuitry 208 includes any means such as a device or circuitry embodied in either hardware or a combination of hardware and software that is configured to receive and/or transmit data from/to a network and/or any other device, circuitry, or module in communication with the apparatus 200. In this regard, in some embodiments the communications circuitry 208 includes, for example, a network interface for enabling communications with a wired or wireless communications network. Additionally or alternatively in some embodiments, the communications circuitry 208 includes one or more network interface card(s), antenna(s), bus(es), switch(es), router(s), modem(s), and supporting hardware, firmware, and/or software, or any other device suitable for enabling communications via one or more communications network(s). Additionally or alternatively, the communications circuitry 208 includes circuitry for interacting with the antenna(s) and/or other hardware or software to cause transmission of signals via the antenna(s) or to handle receipt of signals received via the antenna(s). In some embodiments, the communications circuitry 208 enables transmission to and/or receipt of data from user device, one or more asset(s) or accompanying sensor(s), and/or other external computing device in communication with the apparatus 200.

In some embodiments, the apparatus 200 includes a monitoring and automation circuitry 210. The monitoring and automation circuitry 210 includes hardware, software, firmware, and/or a combination thereof, that supports functionalities of the system 140 described herein according to one or more techniques of the present disclosure. For example, in some embodiments, the monitoring and automation circuitry 210 includes hardware, software, firmware, and/or a combination thereof, configured to, with the processing circuitry 202, input/output circuitry 206 and/or communications circuitry 208, perform one or more functions associated with various components of the software platform 120 including the model execution engine 127, described above with respect to FIGS. 1A-D. In some embodiments, the monitoring and automation circuitry 210 includes a separate processor, specially configured field programmable gate array (FPGA), or a specially programmed application specific integrated circuit (ASIC).

In some embodiments, the apparatus 200 may include AI and machine learning circuitry 212, data intake circuitry, and/or data output circuitry 214. In some embodiments, the data intake circuitry may include hardware, software, firmware, and/or a combination thereof, designed and/or configured to capture, receive, request, and/or otherwise gather data associated with operations of one or more plant(s). In some embodiments, the data intake circuitry includes hardware, software, firmware, and/or a combination thereof, that communicates with one or more sensor(s). unit(s), and/or the like within a particular plant to receive particular data associated with such operations of the plant. The data intake circuitry may support such operations for any number of individual plants. Additionally or alternatively, in some embodiments, the data intake circuitry includes hardware, software, firmware, and/or a combination thereof, that retrieves particular data associated with one mor more plant(s) from one or more data repository/repositories accessible to the apparatus 200.

In some embodiments, the AI and machine learning circuitry 212 may include hardware, software, firmware, and/or a combination thereof designed and/or configured to request, receive, process, generate, and transmit data, data structures, control signals, and electronic information for training and executing a trained AI and machine learning model configured to facilitating the operations and/or functionalities described herein. For example, in some embodiments the AI and machine learning circuitry 212 includes hardware, software, firmware, and/or a combination thereof, that identifies training data and/or utilizes such training data for training a particular machine learning model, AI, and/or other model to generate particular output data based at least in part on learnings from the training data. Additionally or alternatively, in some embodiments, the AI and machine learning circuitry 212 includes hardware, software, firmware, and/or a combination thereof, that embodies or retrieves a trained machine learning model, AI and/or other specially configured model utilized to process inputted data. Additionally or alternatively, in some embodiments, the AI and machine learning circuitry 212 includes hardware, software, firmware, and/or a combination thereof that processes received data utilizing one or more algorithm(s), function(s), subroutine(s), and/or the like, in one or more pre-processing and/or subsequent operations that need not utilize a machine learning or AI model.

In some embodiments, the data output circuitry 214 may include hardware, software, firmware, and/or a combination thereof, that configures and/or generates an output based at least in part on data processed by the apparatus 200. In some embodiments, the data output circuitry 214 includes hardware, software, firmware, and/or a combination thereof, that generates a particular report based at least in part on the processed data, for example where the report is generated based at least in part on a particular reporting protocol. Additionally or alternatively, in some embodiments, the data output circuitry 214 includes hardware, software, firmware, and/or a combination thereof, that configures a particular output data object, output data file, and/or user interface for storing, transmitting, and/or displaying. For example, in some embodiments, the data output circuitry 214 generates and/or specially configures a particular data output for transmission to another system sub-system for further processing. Additionally or alternatively, in some embodiments, the data output circuitry 214 includes hardware, software, firmware, and/or a combination thereof, that causes rendering of a specially configured user interface based at least in part on data received by and/or processing by the apparatus 200.

In some embodiments, two or more of the sets of circuitries 202-214 are combinable. Alternatively or additionally or in some embodiments, one or more of the sets of circuitries embodying processor 202, memory 204, input/output circuitry 206, communications circuitry 208, and/or other circuitries. perform some or all of the functionality described as associated with another component. For example, in some embodiments, two or more of the sets of circuitry embodied by processor 202, memory 204, input/output circuitry 206, communications circuitry 208, and/or other circuitries, are combined into a single module embodied in hardware, software, firmware, and/or a combination thereof.

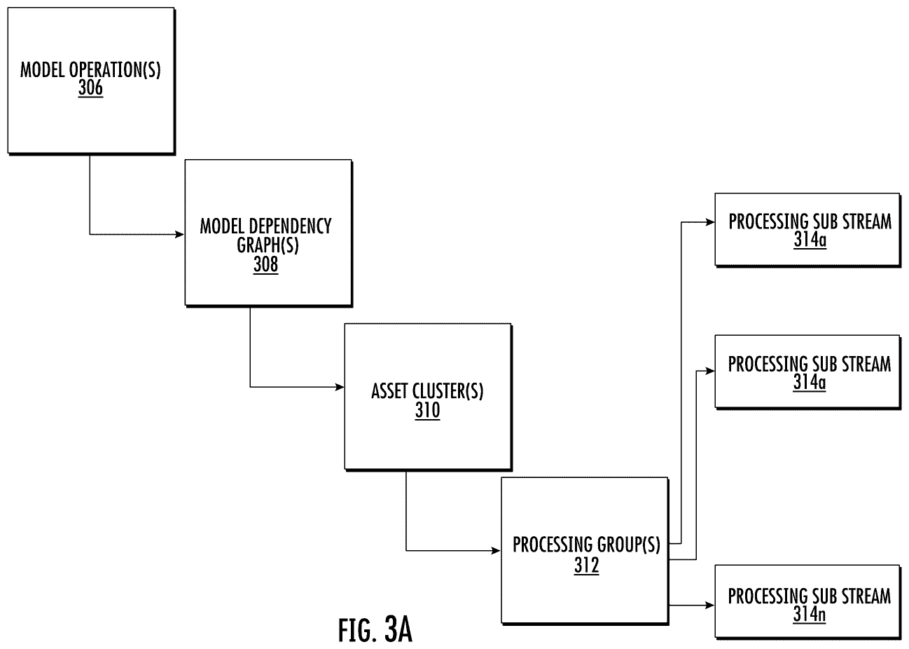

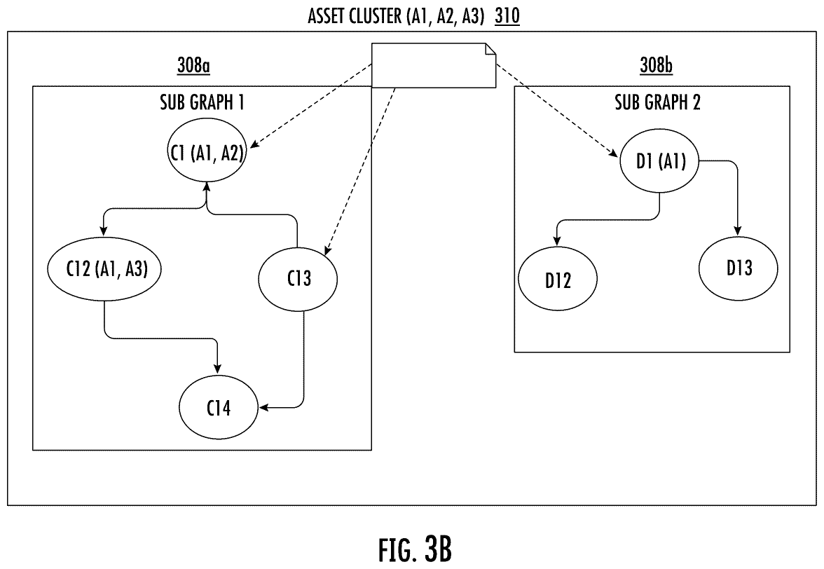

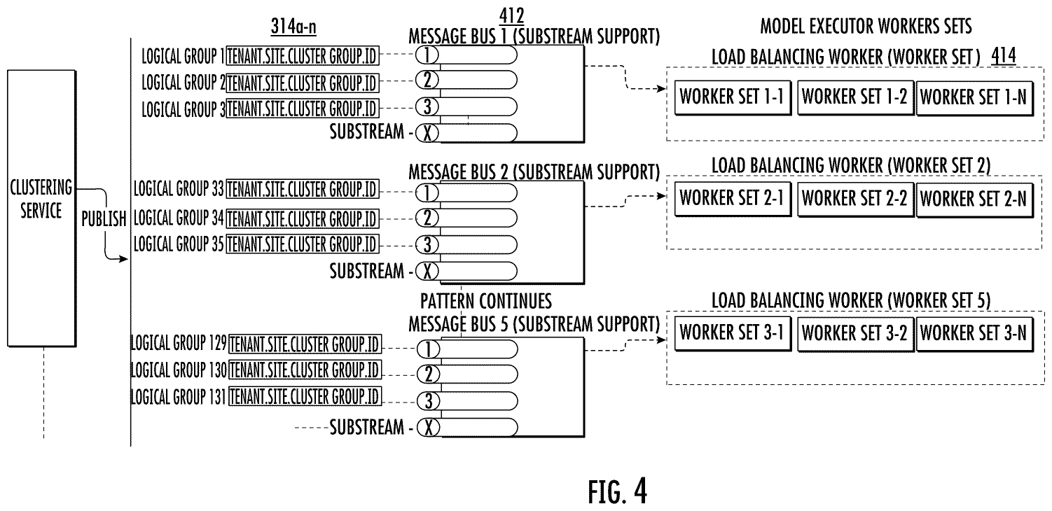

Referencing FIGS. 3A-3B and FIG. 4. In various embodiments, the software platform 120 of the monitoring and automation computing system 140 (e.g., clustering service 130b of the software platform 120 thereof) represents or otherwise comprises a process, subroutine or other component associated with the model execution engine 127 configured to generate the processing groups for a tenant site and leverage the processing groups to route the telemetry data messages received from the edge computing system 160 (e.g., originating from the edge devices 121a-c) to different processing sub streams of a processing pipeline associated with the monitoring and automation computing system 140. The monitoring and automation computing system 140, for example, may be associated with a plurality of processing sub streams that represent a processing pipeline (e.g., data processing pipeline) associated with the monitoring and automation computing system 140, which are leveraged by the model execution engine 127 to process telemetry data. For example, each processing sub stream may represent individual processing pipelines that collectively define the processing pipeline for the monitoring and automation computing system 140.

In various embodiments, the computing system 140 is configured to identify model operations 306 associated with one or more assets associated with a particular site (e.g., a tenant site). In various embodiments, a model operation defines or otherwise comprises one or more input variables corresponding to one or more characteristics or conditions (e.g., environmental conditions, operational conditions, and/or the like) associated with one or more processes at the tenant site. As described above, the edge computing system 160 associated with a tenant site may comprise edge devices 121a-c such as measurement devices deployed at the tenant site or otherwise associated with the tenant site to provide telemetry data or other measurement data quantifying characteristics or conditions associated with one or more assets at a given site, such as, for example, environmental condition and/or operational conditions. In this regard, in various embodiments, a model operation defines or otherwise comprises one or more input variables associated with one or more assets associated with the tenant site, wherein a model operation (or asset models comprising the model operation) is configured to receive portion of telemetry data corresponding to the one or more input variables defined by the model operation indicative of one or more operational conditions associated with the one or more assets at a particular time stamp and/or one or more environmental conditions associated with an environment associated with one or more assets at a particular timestamp.

Referencing FIG. 3B. For example, a first model operation “C1” may comprise a first set of one or more input variables for the first model operation “C1” corresponding to one or more operational conditions of a first asset “A1” and a second set of one or more input variables for the first model operation “C1” corresponding to one or more operational conditions of a second asset “A2”. As another example, a second model operation “C12” may comprise a first set of one or more input variables for the second model operation “C12” corresponding to the one or more operational conditions of the first asset “A1” and a second set of one or more input variables for the second model operation “C12” corresponding to one or more operational conditions of a third asset “A3”. As yet another example, a third model operation “D1” may comprise a first set of one or more input variables for the third model operation “C3” corresponding to the one or more operational conditions of a first asset “A1”.

In some embodiments, an asset may represent a parent asset associated with one or more child assets. By way of example, a pump may include one or more bearings. In such example, the pump may represent a parent asset and the one or more bearings may represent child asset(s). In various embodiments, a model operation may be configured to calculate a particular output for a parent asset based on measurement data for one or more characteristics or conditions associated with the parent asset, one or more characteristics or conditions (e.g., environmental conditions, operational conditions, or the like) associated with one or more child assets of the parent asset, and/or one or more characteristics or conditions associated with one or more other assets associated with the tenant site.

In various example implementations, the model operations associated with the tenant site may be interrelated in that the output of a first model operation may represent an input to a second model operation. Still referencing the simplified example illustrated in FIG. 3B, the output of the first model operation “C1” may be an input to the second model operation “C12”. As another example, the output of the first model operation “C1” may be an input to the third calculation “C13”. As yet another example, the output of each of the second model operation “C12” and the third model operation “C13” may be inputs to a fourth model operation “C14”. In this this regard, in some example implementations, at least a portion of the model operations for a tenant site may have dependency relationships.

In various embodiments, the monitoring and automation computing system 140 (e.g., clustering service 130b is configured to identify such dependency relationships and generate one or more model dependency graphs 308 such as model dependency graphs 308a and 308b illustrated in FIG. 3b.

In various embodiments, each model dependency graph comprises a unique subset of the model operations of the tenant site that have a dependency relationship. For example, as shown in the simplified example illustrated in FIG. 3B. A first model dependency graph for the example tenant site may comprise model operations “C1”, “C12”, “C13”, and “C14” having a dependency relationship, wherein model operations “C12” and “C13” each depend, directly, on model operation “C1” and model operation “C14” depends, directly, on model operations “C12” and “C13” and depends, indirectly, on model operation “C1”. As another example, a second model dependency graph for the example tenant site may comprise model operations “D1”, “D12”, and “D13”, wherein model operations “D12” and “D13” each depend, directly, on model operation “D1”. In this regard, a particular model operation may depend on other model operation if the input to the particular model includes the output of the other model operation.

In various embodiments, the monitoring and automation computing system 140 (e.g., clustering service 130b thereof) leverages a graph machine learning model to generate the model dependency graphs.

In some embodiments, the graph machine learning model is a data entity that describes parameters, hyper-parameters, and/or defined operations of a rules-based algorithm and/or machine learning model (e.g., model including at least one or more rule-based layers, one or more layers that depend on trained parameters, coefficients, and/or the like), and/or artificial intelligence model, and/or the like. A graph machine learning model may include any type of model configured, trained, and/or the like to generate model dependency graphs. In this regard, a graph machine learning model may be configured to utilize one or more of any types of machine learning, rules-based, and/or artificial intelligence techniques including one or more of computer vision techniques, supervised learning (e.g., using user feedback), unsupervised learning, semi-supervised learning, reinforcement learning, computer vision techniques, sequence modeling techniques, language processing techniques, neural network techniques, and/or generative artificial intelligence techniques. For example, the graph machine learning model may be configured to employ relationship detection techniques with respect to model operations associated with one or more assets to generate model dependency graphs for the one or more assets.

In various embodiments, the monitoring and automation computing system 140 (e.g., clustering service 130b thereof) is configured to generate one or more asset clusters 310 based on the model dependency graphs 308. In various embodiments, each asset cluster comprises one or more model dependency graphs, wherein each model dependency graph in an asset cluster is related to at least one other model dependency graph in the asset cluster by having at least one model operation having an input variable associated with the same asset as another input variable of a model operation in the at least one other model dependency graph in the asset cluster. For example, as shown in the example illustrated in FIG. 3B, the first model dependency graph and the second model dependency graph each include input variables associated with the first asset “A1”.

In various embodiments, the clustering service 130b leverages a clustering machine learning model to generate the one or more asset clusters for a tenant site by applying the model dependency graphs or data representative of the model dependency graph to the clustering machine learning model.

In some embodiments, the clustering machine learning model is a data entity that describes parameters, hyper-parameters, and/or defined operations of a rules-based algorithm and/or machine learning model (e.g., model including at least one or more rule-based layers, one or more layers that depend on trained parameters, coefficients, and/or the like), and/or artificial intelligence model, and/or the like. A clustering machine learning model may include any type of model configured, trained, and/or the like to generate asset clusters. In this regard, a clustering machine learning model may be configured to utilize one or more of any types of machine learning, rules-based, and/or artificial intelligence techniques including one or more of computer vision techniques, supervised learning (e.g., using user feedback), unsupervised learning, semi-supervised learning, reinforcement learning, computer vision techniques, sequence modeling techniques, language processing techniques, neural network techniques, and/or generative artificial intelligence techniques. For example, the clustering machine learning model may be configured to employ clustering techniques with respect to model dependency graphs 308 to generate asset cluster(s) 310 for the one or more assets.

In various embodiments, the monitoring and automation computing system 140 (e.g., clustering service 130b thereof) generates one or more processing groups 312, each comprising at least one asset cluster of the one or more asset clusters 310 and having a predetermined maximum number of model operations. For example, a processing group may comprise one or more asset clusters, where the aggregate of the model operations associated with the one or more asset clusters in the processing group does not exceed a predetermined maximum number of model operations. In various embodiments, the predetermined maximum number of model operations is the maximum number of model operations at which processing performance (e.g., processing latency and/or or other performance metrics), by the processing pipeline associated with the monitoring and automation computing system 140, of telemetry data messages originating from the edge devices associated with the tenant site is not impacted taking into account both normal execution and backfilling execution.

In various embodiments, normal execution represents execution of one or more asset monitoring models defining the model operations for the tenant site using real-time or near real-time telemetry data messages (e.g., application of real-time or near real-time telemetry data to the one or more asset monitoring models). In various embodiments, backfilling execution represents execution of one or more asset monitoring models defining the model operations for the tenant site using backlogged historical telemetry data (e.g., application of historical telemetry data to the one or more asset monitoring models). In this regard, the clustering service 130b may be configured to group the assets clusters into one or more groups having a predetermined maximum number of model operations without impacting expected data processing performance (e.g., processing latency or other performance metrics) for normal execution and expected data processing performance (e.g., processing latency or other performance metrics) for backfilling execution.

In this regard, in various embodiments, each processing group 312 is associated with a processing group size (e.g., defined by number of model operations in a processing group) that ensures expected processing performance (e.g., data processing performance) is achieved. In this regard, a tenant site may be associated with a certain number of processing groups that are assigned to separate processing sub streams 314a-n of a processing pipeline associated the monitoring and automation computing system 140. In this regard, the number of processing sub streams for a tenant site corresponds to the number of processing groups for the tenant site.

In various embodiments, the monitoring and automation computing system 140 (e.g., clustering service 130b thereof) determines the number of processing sub streams for a tenant site (e.g., corresponding to the number of processing groups for the tenant site) based on one or more grouping parameters. A grouping parameter as used herein may describe criteria for grouping asset clusters into processing groups. In various embodiments, the one or more grouping parameters include backfill latency threshold, expected execution frequency, site-specific model operation count, worker model operation count (e.g., processor worker model operation count).

In various embodiments, backfill latency threshold describes the maximum amount of time to process a given volume of backlogged telemetry data. In some example implementations backfill latency threshold may be defined in terms of a ratio of volume of backlogged telemetry data in units of time and maximum processing time. By way of example, backfill latency of 5:1 may be representative and/or indicative of a maximum processing time of one hour for five hours of backlogged telemetry data for the tenant site.

In various embodiments, expected execution frequency is the frequency of model execution in a given time window (e.g., one minute, five minutes, or the like). In various embodiments, expected execution frequency is data driven and may depend on the domain. By way of non-limiting example, in a refinery domain, telemetry data may be collected and/or sampled by the edge computing system 160 associated with the tenant site every 30 seconds. As another non-limiting example, in a mining domain, telemetry data may be collected and/or sampled by the edge computing system 160 associated with the tenant site at sub-seconds frequency. In some implementations, such sub-second frequency may be bucketed (e.g., micro batched) to 1 second time window.

In various embodiments, site-specific model operation count is the number of model operations configured or otherwise defined in the tenant site (e.g., number of model operations to performed on telemetry data messages from the tenant site).

In various embodiments, worker model operation count represents optimal number of model operations to be executed in a processor worker at maximum load based on the worker size (e.g., CPU, memory, and/or hosted Environment). In various embodiment, processor worker model operation count is determined through PSR qualification.

In various embodiments, the maximum number of model operations for each processing sub stream (e.g., number of model operations per processing sub stream) for a tenant site and number of processing sub streams for the tenant site (e.g., corresponding to the number of processing groups for the tenant site) are determined by performing the following operations:

$$Equation 1$$

$$Number of model operations {per}_{stream} = \frac{worker model operation count}{\frac{expected execution frequency}{backfill latency threshold}}$$

$$Number of {processing}_{streams} per site = \frac{site specific model operation count}{Number of model operations by {per}_{stream}} \qquad Equation 2$$

In various embodiments, the monitoring and automation computing system 140 (e.g., clustering service 130b) performs an iterative processing group assignment process to assign processing groups for the tenant site to different processing sub streams 314a-n. In some embodiments, the iterative processing group assignment task comprises assigning the asset clusters to a first asset processing group associated with a first processing group identifier for the tenant site (e.g. tenant site processing group identifier) until the number of the model operations in the first processing group is at a maximum number that does not exceed the number of model operations per sub stream, such that introduction of additional asset cluster to the first processing group would cause the number of model operations in the first processing group to exceed the number of model operations processing per sub streams.

The iterative processing group assignment process further comprises in such embodiments, in response to reaching the first processing group reaching the maximum number that does not exceed the number of model operations per sub stream, assigning asset clusters from the remaining asset clusters for the tenant site to a second asset processing group until the number of the model operations in the second processing group is at a maximum number that does not exceed the number of model operations per sub stream, such that introduction of additional asset cluster to the second processing group would cause the number of model operations in the second processing group to exceed the number of model operations per sub streams.

The iterative processing group assignment process may be terminated in response to assigning all asset clusters for the tenant site to a processing group. In this regard, each asset cluster for the tenant site is assigned to a particular processing group corresponding to or otherwise associated with a particular processing sub stream of one or more processing sub streams of a processing pipeline associated with the monitoring and automation computing system 140. For example, each processing sub stream may represent an independent processing pipeline.

As described above, in various embodiments, in response to receiving telemetry messages (e.g., comprising telemetry data originating from, for example, edge devices 121a-n) associated with one or more assets associated with a tenant site, the computing system 140 (e.g., clustering service 130b thereof is configured to analyze the telemetry data messages and route the telemetry data messages to the pre-assigned processing sub streams 314a-n (as described above) for the tenant site based on the processing group associated with respective portions (e.g., subsets) of the telemetry data messages. In this regard, in various embodiments, the monitoring and automation computing system 140 (e.g., clustering service 130b thereof) is configured to analyze telemetry data associated with a tenant site to segment the telemetry data messages into one or more message streams corresponding to predetermined processing groups for the tenant site identifier and route each of the one or more message streams (e.g., processing groups) to the corresponding pre-assigned processing sub streams associated with the monitoring and automation computing system 140. In some embodiments, analyzing the telemetry data comprises identified the site identifier (e.g., tenant site identifier) associated with the telemetry data.

In some embodiments, the term “site identifier”, “tenant site identifier” used herein interchangeably refers to one or more items or elements by which a site may be uniquely identified from other sites. For instance, a site identifier may be configured to uniquely identify a site associated with a particular user (e.g., tenant) from other sites associated with the particular user or other users. A site identifier may be in the form of text string(s), numerical character(s), alphabetical character(s), alphanumeric code(s), American Standard Code for information Interchange (ASCII) characters(s), and/or the like.

In various embodiments, routing telemetry data messages to different processing sub streams associated with the monitoring and automation computing system 140 comprises assigning the telemetry data messages to different message buses 412 based on the processing group associated with the respective portions of the telemetry data messages. In various embodiments, the respective portions (e.g., subsets) of the telemetry data messages corresponding to respective processing groups are mutually exclusive, such that respective portions of the telemetry data messages are assigned to only one of the message buses 412.

In various embodiments, the messages buses 412 represents or otherwise comprises data streaming services or other components associated with the monitoring and automation computing system 140 (e.g., software platform 120 thereof) or processing service that supports processing telemetry data messages with high throughput and low latency. In this regard, the message buses 412 may be configured to function as an event bus or event hub that maintains telemetry data messages assigned to the respective message bus 412 (e.g., in a queue or buffer) for retrieval and processing by processor workers of processor worker sets 414.

In various embodiments, the processing subs streams (e.g., message buses 412) are executed in parallel. Additionally, in various embodiments, the model operations in a processing sub stream (e.g., message buses 412) are executed in sequence. By utilizing processing sub streams as described herein and parallel processing of these processing sub streams, example embodiments of the present disclosure increase throughput of the processing pipeline.

In this regard, in various embodiments, each processing sub stream or includes a throttling mechanism with respect to hardware resource consumption and number of telemetry data messages being processed in a given time interval (e.g., corresponding to number of model operations being executed by applying the telemetry data messages to models) such that a processor worker in a processor worker set 414 processes telemetry data messages in at least a subset of processing sub streams assigned to the tenant site in accordance with round robin technique or other suitable processor scheduling techniques that ensures substantially balanced load across processing sub streams associated with a tenant site. In this regard, the processing sub streams and throttling mechanism ensures that each processing sub stream has a minimum opportunity to process the telemetry data messages and execute/perform model operations, whereby ensuring that one or few processing sub streams do not consume or otherwise utilize the entire compute resources (processors workers in a worker set) which results in noisy neighbor scenario.

### Example Processes/Methods of the Disclosure

Having described example systems and apparatuses, and data visualizations in accordance with the disclosure, example processes/methods of the disclosure will now be discussed. It will be appreciated that each of the flowcharts depicts an example computer-implemented process that is performable by one or more of the apparatuses, systems, devices, and/or computer program products described herein, for example utilizing one or more of the specially configured components thereof.

Although the example processes depicts a particular sequence of operations, the sequence may be altered without departing from the scope of the present disclosure. For example, some of the operations depicted may be performed in parallel or in a different sequence that does not materially affect the function of the processes.

The blocks indicate operations of each process. Such operations may be performed in any of a number of ways, including, without limitation, in the order and manner as depicted and described herein. In some embodiments, one or more blocks of any of the processes described herein occur in-between one or more blocks of another process, before one or more blocks of another process, in parallel with one or more blocks of another process, and/or as a sub-process of a second process. Additionally or alternatively, any of the processes in various embodiments include some or all operational steps described and/or depicted, including one or more optional blocks in some embodiments. With regard to the flowcharts illustrated herein, one or more of the depicted block(s) in some embodiments is/are optional in some, or all, embodiments of the disclosure. Optional blocks are depicted with broken (or “dashed”) lines. Similarly, it should be appreciated that one or more of the operations of each flowchart may be combinable, replaceable, and/or otherwise altered as described herein.

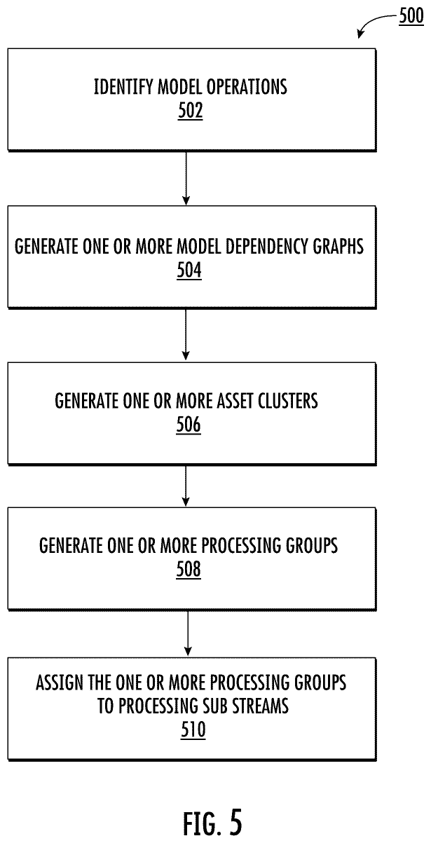

FIG. 5 illustrates a flowchart for generating processing groups in accordance with at least one example embodiment of the present disclosure. In particular, FIG. 5 illustrates a flow chart for assigning processing sub streams for a tenant site. In some embodiments, the process/method 500 is embodied by computer program code stored on a non-transitory computer-readable storage medium of a computer program product configured for execution to perform the process as depicted and described. Alternatively or additionally, in some embodiments, the process/method 500 is performed by one or more specially configured computing devices, such as the apparatus 200 alone or in communication with one or more other component(s), device(s), system(s), and/or the like. In this regard, in some such embodiments, the apparatus 200 is specially configured by computer-coded instructions (e.g., computer program instructions) stored thereon, for example in the memory 204 and/or another component depicted and/or described herein and/or otherwise accessible to the apparatus 200, for performing the operations as depicted and described. In some embodiments, the apparatus 200 is in communication with one or more external apparatus(es), system(s), device(s), and/or the like, to perform one or more of the operations as depicted and described. For example, the apparatus 200 in some embodiments is in communication with separate component(s) of a network, external network(s), and/or the like, to perform one or more of the operation(s) as depicted and described. For purposes of simplifying the description, the process/method 500 is described as performed by and from the perspective of the apparatus 200.

Although the example process/method 500 depicts a particular sequence of operations, the sequence may be altered without departing from the scope of the present disclosure. For example, some of the operations depicted may be performed in parallel or in a different sequence that does not materially affect the function of the process/method 500. In other examples, different components of an example device or system that implements the process/method 500 may perform functions at substantially the same time or in a specific sequence.

According to some examples, the process/method 500 includes, at block 502, identifying model operations associated with a tenant site. For example, the apparatus 200 may identify model operations for each tenant site of a plurality of tenant sites.

In various embodiments, each model operation defines or otherwise comprises one or more input variables corresponding to one or more characteristics or conditions associated with one or more assets at the tenant site. In this regard, a model operation may include a single input variable corresponding to a characteristic or condition associated with an asset at the tenant site or otherwise associated with the tenant site or may include or a plurality of input variables corresponding to a plurality characteristics or conditions associated with one or more assets at the tenant site or otherwise associated with the tenant site. Such characteristics or conditions associated with an asset may be referred to herein as asset conditions, including asset environmental conditions and/or asset operational conditions. Non-limiting examples of asset environmental conditions include temperature, humidity, and/or the like in an environment of an asset. Non-limiting examples of asset operational conditions include fluid properties, flow rate, and/or other the like.

For example, a first model operation “C1” may comprise a first set of one or more input variables for the first model operation “C1” corresponding to one or more operational conditions of a first asset “A1” and a second set of one or more input variables for the first model operation “C1” corresponding to one or more operational condition of a second asset “A2”. As another example, a second model operation “C12” may comprise a first set of one or more input variables for the second model operation “C12” corresponding to the one or more operational conditions of the first asset “A1” and a second set of one or more input variables for the second model operation “C12” corresponding to one or more operational conditions of a third asset “A3”. As yet another example, a third model operation “D1” may comprise a first set of one or more input variables for the third model operation “C3” corresponding to the one or more operational conditions of a first asset “A1”.

In various example implementations, at least a subset of the model operations associated with the tenant site may be interrelated in that the output of a first model operation may represent an input to a second model operation. For example, the output of the first model operation “C1” may be an input to the second model operation “C12”. As another example, the output of the first model operation “C1” may be an input to the third calculation “C13”. As yet another example, the output of each of the second model operation “C12” and the third model operation “C13” may be inputs to a fourth model operation “C14”. In this this regard, in some example implementations, at least a portion of the model operations for a tenant site may have dependency relationships.

According to some examples, the process/method 500 includes, at block 504, generating one or more model dependency graphs for a tenant site based on the identified model operations. For example, the apparatus 200 may generate a plurality of dependency graph structures for a tenant site based on the identified model operations for the tenant site. In some embodiments, generating the model dependency graphs comprises applying the model operations (or data representative or indicative of the model operations) for the tenant site to a graph machine learning model configured to identify dependency relationships between and/or among the model operations, and generate model dependency graphs based on the dependency relationships. For example, the apparatus 200 may input the identified model operations for the tenant site into the graph machine learning model and obtain the model dependency graphs output from the graph machine learning model.

In various embodiments, each model dependency graph comprises a unique subset of the model operations of the tenant site that have a dependency relationship. For example, a first model dependency graph for an example tenant site may comprise model operations “C1”, “C12”, “C13”, and “C14” having a dependency relationship, wherein model operations “C12” and “C13” each depend, directly, on model operation “C1” and model operation “C14” depends, directly, on model operations “C12” and “C13” and depends, indirectly, on model operation “C1”. As another example, a second model dependency graph for the example tenant site may comprise model operations “D1”, “D12”, and “D13”, wherein model operations “D12” and “D13” each depend, directly, on model operation “D1”. In this regard, a particular model operation may depend on other model operation if the input to the particular model includes the output of the other model operation.

According to some examples, the process/method 500 includes, at block 506, generating one or more asset clusters based on the model dependency graphs. For example, the apparatus 200 generates one or more asset clusters by identifying common assets represented in the model dependency graphs. In various embodiments, an asset cluster comprises one or more model dependency graphs, wherein each model dependency graph in an asset cluster is related to at least one other model dependency graph in the asset cluster by having at least one model operation having an input variable associated with the same asset as another input variable for a model operation in the at least one other model dependency graph in the asset cluster. For example, the first model dependency graph and the second model dependency graph each include input variables associated with the first asset “A1”.

According to some examples, the process/method 500 includes, at block 508, generating one or more processing groups. For example, the apparatus 200 may generate one or more processing groups each comprising at least one asset cluster of the one or more asset clusters (e.g., generated at block 506) and having a predetermined maximum number of model operations. For example, a processing group may comprise one or more asset clusters, where the aggregate of the model operations associated with the one or more asset clusters in the processing group does not exceed a predetermined maximum number of model operations.

In various embodiments, the predetermined maximum number of model operations is the maximum number of model operations at which processing performance (e.g., processing latency and/or or other performance metrics), by the processing pipeline associated with the apparatus 200, of telemetry data messages originating from the edge devices associated with the tenant site is not impacted taking into account both normal execution and backfilling execution, as described above. In this regard, the apparatus 200 may group the assets clusters into one or more groups having a predetermined maximum number of model operations without impacting expected data processing performance (e.g., processing latency or other performance metrics) for normal execution and expected data processing performance (e.g., processing latency or other performance metrics) for backfilling execution. In this regard, in various embodiments, each processing group is associated with a processing group size (defined by number of model operations in a processing group) that ensures expected data processing performance is achieved.

According to some examples, the process/method 500 includes, at block 510, assigning the one or more processing groups for the tenant site to a processing sub stream. For example, the apparatus may assign each of the one or more processing groups to a particular processing sub stream of a processing pipeline, wherein each processing sub stream represents independent processing pipelines. In this regard, in some embodiments, the apparatus 200 generates one or more processing groups for a tenant site, such that the tenant site is associated with a certain number of processing groups that are assigned to separate processing sub streams of a processing pipeline associated the apparatus 200. For example, the number of processing sub streams for a tenant site may correspond to the number of processing groups for the tenant site.

In various embodiments, the apparatus 200 determines the number of processing sub streams for a tenant site (e.g., corresponding to the number of processing groups for the tenant site) based on one or more grouping parameters. In various embodiments, the one or more grouping parameters include backfill latency threshold, expected execution frequency, site-specific model operation count, and/or processor worker model operation count, as described above. In some embodiments, the number of model operations per processing sub stream for a tenant site and number of processing sub streams for the tenant site (e.g., corresponding to the number of processing groups for the tenant site) are determined by performing the operations in equation 1 and equation 2 described above.

In various embodiments, the apparatus 200 performs an iterative processing group assignment process to assign processing groups for the tenant site to different processing sub streams. In some embodiments, the iterative processing group assignment task comprises assigning the asset clusters to a first asset processing group associated with a first processing group identifier for the tenant site (e.g. tenant site processing group identifier) until the number of the model operations in the first processing group is at a maximum number that does not exceed the number of model operations per sub stream, such that introduction of additional asset cluster to the first processing group would cause the number of model operations in the first processing group to exceed the number of model operations per sub streams.

The iterative processing group assignment process further comprises in such embodiments, in response to reaching the first processing group reaching the maximum number that does not exceed the number of model operations per sub stream, assigning asset clusters from the remaining asset clusters for the tenant site to a second asset processing group until the number of the model operations in the second processing group is at a maximum number that does not exceed the number of model operations per sub stream, such that introduction of additional asset cluster to the second processing group would cause the number of model operations in the second processing group to exceed the number of model operations per sub streams.

The iterative processing group assignment process may be terminated in response to assigning all asset clusters for the tenant site to a processing group. In this regard, each asset cluster for the tenant site is assigned to a particular processing group corresponding to or otherwise associated with a particular processing sub stream of one or more processing sub streams of a processing pipeline associated with the apparatus 200. For example, each processing sub stream may represent an independent processing pipeline.

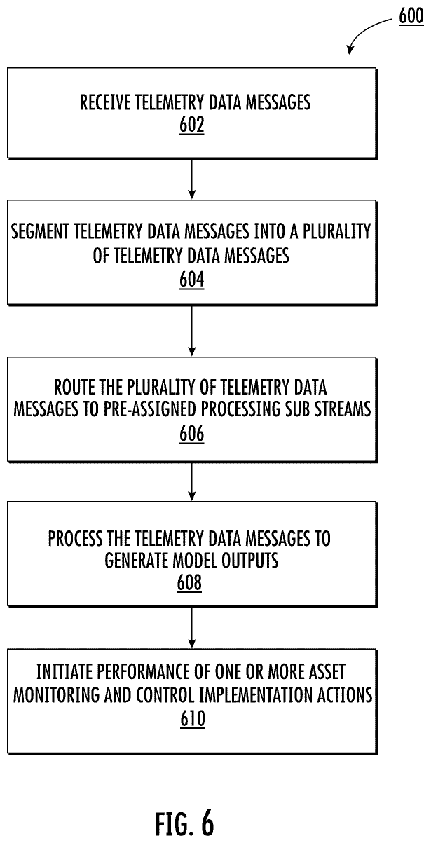

FIG. 6 illustrates a flowchart for processing telemetry data messages for tenant sites in accordance with at least one example embodiment of the present disclosure. In some embodiments, the process/method 600 is embodied by computer program code stored on a non-transitory computer-readable storage medium of a computer program product configured for execution to perform the process as depicted and described. Alternatively or additionally, in some embodiments, the process/method 600 is performed by one or more specially configured computing devices, such as the apparatus 200 alone or in communication with one or more other component(s), device(s), system(s), and/or the like. In this regard, in some such embodiments, the apparatus 200 is specially configured by computer-coded instructions (e.g., computer program instructions) stored thereon, for example in the memory 204 and/or another component depicted and/or described herein and/or otherwise accessible to the apparatus 200, for performing the operations as depicted and described. In some embodiments, the apparatus 200 is in communication with one or more external apparatus(es), system(s), device(s), and/or the like, to perform one or more of the operations as depicted and described. For example, the apparatus 200 in some embodiments is in communication with separate component(s) of a network, external network(s), and/or the like, to perform one or more of the operation(s) as depicted and described. For purposes of simplifying the description, the process/method 600 is described as performed by and from the perspective of the apparatus 200.

Although the example process/method 600 depicts a particular sequence of operations, the sequence may be altered without departing from the scope of the present disclosure. For example, some of the operations depicted may be performed in parallel or in a different sequence that does not materially affect the function of the process/method 600. In other examples, different components of an example device or system that implements the process/method 600 may perform functions at substantially the same time or in a specific sequence.

According to some examples, the process/method 600 includes, at block 602, receiving telemetry data messages associated with one or more assets. For example, the apparatus 200 may receive telemetry data messages for one or more assets associated with a tenant site. In various embodiments, the telemetry data messages comprise telemetry data originating from one or more edge devices (e.g., measuring devices) configured for measuring asset conditions (e.g., asset environmental conditions, asset performance conditions, and/or the like) for the one or more assets.

According to some examples, the process/method 600 includes, at block 604, segmenting the telemetry data messages into a plurality of telemetry data messages based on predetermined/pre-assigned processing groups for the tenant site. For example, the apparatus 200 may analyze the telemetry data messages to identify corresponding processing groups for various portions of the telemetry data messages.

According to some examples, the process/method 600 includes, at block 606, routing the plurality of telemetry data messages (corresponding to a plurality of processing groups for the tenant site) to pre-assigned processing sub streams of a processing pipeline associated with the apparatus 200. In this regard, the apparatus 200 may be configured to route the telemetry data messages to different processing sub streams representing individual processing pipelines.

In various embodiments, routing the telemetry data messages to different processing sub streams of a processing pipeline comprises assigning the telemetry data messages to different message buses based on the processing group associated with the respective portions of the telemetry data messages. In various embodiments, the respective portions (e.g., subsets) of the telemetry data messages corresponding to respective processing groups are mutually exclusive, such that respective portions of the telemetry data messages are assigned to only one of the message buses.

In various embodiments, the messages buses represents or otherwise comprises data streaming services or other components associated with the apparatus 200 that support processing telemetry data messages with high throughput and low latency. In this regard, the message buses may be configured to function as an event bus or event hub that maintains telemetry data messages assigned to the respective message bus (e.g., in a queue or buffer) for retrieval and processing by processor workers.

According to some examples, the process/method 600 includes, at block 608, processing the telemetry data messages in parallel to generate model outputs. For example, the apparatus 200 may process the telemetry data messages in the processing sub streams in parallel based on the processing group associated with the telemetry data messages. As described above, in various embodiments, a processing group comprises one or more asset clusters, wherein each asset cluster comprises one or more model dependency graphs each defining or otherwise comprising one or more model operations. In this regard, in some embodiments, processing the telemetry data messages in a message bus comprises executing the model dependency graphs in the message bus in parallel. The capability to execute the model dependency graphs in a message bus in parallel is enabled by having independent model dependency graphs relative to other model dependency graphs in the asset clusters in the processing group. For example, in various embodiments, the model operations in the model dependency graphs in an asset cluster do not have a dependency relationship relative to the model operations in other model dependency graphs in the asset cluster and relative to the model operations in other asset clusters in the processing group.

In various embodiments, executing a model dependency graph comprises executing the model operations in the model dependency graph structure in a sequential order. For example, the apparatus 200, using one or more processor workers associated with the processing sub streams, may execute the model operations in a model dependency graph in accordance with the processing sequence defined by the model dependency graph. For example, the apparatus 200 (e.g., via a processor worker) may execute model operations in a model dependency graph by applying relevant telemetry data to a first mathematical model defining a first model operation in the model dependency graph that is the first in the processing sequence defined by the model dependency graph.

At least one output may be generated as a result of executing the first mathematical model, wherein the least one output represents an input to a second mathematical model defining a second model operation in the model dependency graph that is the second in the processing sequence defined by the model dependency graph. The apparatus 200 may be configured to execute the second mathematical model in response to obtaining the output of the first mathematical model, wherein executing the second mathematical model comprises applying the at least one output obtained from executing the first mathematical model and/or other relevant portions of the telemetry data to the second mathematical model. In various embodiments, the apparatus 200 (using the processor workers) is configured to execute other models defining other model operations in the model dependency graph similar to the execution process for the first and second models.

By utilizing processing sub streams as described herein and parallel processing of these processing sub streams, example embodiments of the present disclosure increase throughput of the processing pipeline.

In various embodiments, a processor scheduling technique is employed to ensure that computing resources are not unevenly distributed (e.g., to ensure that one or a few processing sub streams do not consume or otherwise utilize a substantial amount or entire compute resources (e.g., processor workers in a processor worker set)). In some embodiments, such processor scheduling technique includes round robin scheduling technique, wherein each process worker is cyclically assigned a number of telemetry data messages to process (e.g., or model operations to execute) for each processing sub stream of a set of processing sub streams. For example, a particular processor worker in a processor worker set associated with the processing sub streams assigned to a tenant site may be configured to process a predetermined number (e.g., 5, 10, 15, or any suitable number) of telemetry messages in a first processing sub stream, and in response to completion of the processing of the predetermined number of telemetry messages in the first processing sub stream, process the predetermined number of telemetry messages in a second processing sub stream, and so on for the processor worker set.

In this regard, in various embodiments, each processing sub stream or includes a throttling mechanism with respect to hardware resource consumption and number of telemetry data messages being processed in a given time interval (e.g., corresponding to number of model operations being executed by applying the telemetry data messages to models) such that a processor worker processes telemetry data messages in at least a subset of processing sub streams assigned to the tenant site in accordance with round robin technique or other suitable processor scheduling techniques that ensures substantially balanced load across processing sub streams associated with a tenant site. In this regard, the processing sub streams and throttling mechanism ensures that each processing sub stream has a minimum opportunity to process the telemetry data messages and execute/perform model operations, whereby ensuring that one or few processing sub streams do not consume or otherwise utilize the entire compute resources (processors workers in a worker set) which results in noisy neighbor scenario in industrial scalable calculation systems.

According to some examples, processing the telemetry data messages for a tenant site comprises provisioning (e.g., spinning up) one or more additional worker groups in response to determining that the processing sub streams assigned to the tenant site are associated with a higher load to process, such as increased number of telemetry data messages to process for the tenant site for a given time interval, increased resource consumption by the worker groups associated with processing sub streams assigned to the tenant site, and/or the like. For example, the apparatus 200 may provision additional worker group(s) in response to determining that the number of telemetry data messages to process for the tenant site for a given time interval is high (e.g., exceeds expected number of telemetry data to be process for the tenant site for a given time interval) and/or in response to determining that the resource consumption (e.g., CPU, processing speed, memory, and/or the like) for the current processor workers provisioned to process telemetry data messages for the tenant site is high (e.g., the resource consumption exceeds an expected resource consumption amount or predetermined resource consumption amount threshold). Such additional worker groups may be provisioned to support the higher load.

According to some example, the process/method 600 includes, at block 610, initiating performance of one or more asset monitoring and control implementation actions. In some embodiments, initiating performance of one or more asset monitoring and control implementation actions comprises providing the outputs of the model operation execution to client computing devices 102; generating and providing alerts, notifications, and/or the like to a user, providing reconfiguration data for one or more assets and/or processes, automatically adjusting the configuration of one or more assets or processes, providing one or more items of data representative and/or indicative of one or more detected faults for one or more assets; one or more items of data representative and/or indicative of one or more predicted faults for one or more assets; and/or one or more items of data representative and/or indicative of one or more performance indicators (e.g., key performance indicators (KPI)) for one or more assets; one or more items of data representative and/or indicative of one or more root causes for abnormal conditions and/or identified faults (e.g., detected faults, and/or predicted faults) for one or more assets; one or more items of data representative and/or indicative of one or more corrective actions for resolving abnormal conditions and/or identified faults for one or more assets; and/or other data that may be used for effective monitoring, control, and/or automation of asset(s) associated with a site.

### Conclusion

Although an example processing system has been described above, implementations of the subject matter and the functional operations described herein can be implemented in other types of digital electronic circuitry, or in computer software, firmware, or hardware, including the structures disclosed in this specification and their structural equivalents, or in combinations of one or more of them.

Embodiments of the subject matter and the operations described herein can be implemented in digital electronic circuitry, or in computer software, firmware, or hardware, including the structures disclosed in this specification and their structural equivalents, or in combinations of one or more of them. Embodiments of the subject matter described herein can be implemented as one or more computer programs, i.e., one or more modules of computer program instructions, encoded on computer storage medium for execution by, or to control the operation of, information/data processing apparatus. Alternatively, or in addition, the program instructions can be encoded on an artificially-generated propagated signal, e.g., a machine-generated electrical, optical, or electromagnetic signal, which is generated to encode information/data for transmission to suitable receiver apparatus for execution by an information/data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially-generated propagated signal. The computer storage medium can also be, or be included in, one or more separate physical components or media (e.g., multiple CDs, disks, or other storage devices).

The operations described herein can be implemented as operations performed by an information/data processing apparatus on information/data stored on one or more computer-readable storage devices or received from other sources.

The term “data processing apparatus” encompasses all kinds of apparatus, devices, and machines for processing data, including by way of example a programmable processor, a computer, a system on a chip, or multiple ones, or combinations, of the foregoing. The apparatus can include special purpose logic circuitry, e.g., an FPGA (field programmable gate array) or an ASIC (application-specific integrated circuit). The apparatus can also include, in addition to hardware, code that creates an execution environment for the computer program in question, e.g., code that constitutes processor firmware, a protocol stack, a repository management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or information/data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described herein can be performed by one or more programmable processors executing one or more computer programs to perform actions by operating on input information/data and generating output. Processors suitable for the execution of a computer program include, by way of example, both general and special purpose microprocessors, and any one or more processors of any kind of digital computer. Generally, a processor will receive instructions and information/data from a read-only memory or a random access memory or both. The essential elements of a computer are a processor for performing actions in accordance with instructions and one or more memory devices for storing instructions and data. Generally, a computer will also include, or be operatively coupled to receive information/data from or transfer information/data to, or both, one or more mass storage devices for storing data, e.g., magnetic, magneto-optical disks, or optical disks. However, a computer need not have such devices. Devices suitable for storing computer program instructions and information/data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, embodiments of the subject matter described herein can be implemented on a computer having a display device, e.g., a CRT (cathode ray tube) or LCD (liquid crystal display) monitor, for displaying information/data to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Embodiments of the subject matter described herein can be implemented in a computing system that includes a back-end component, e.g., as an information/data server, or that includes a middleware component, e.g., an application server, or that includes a front-end component, e.g., a client computer having a graphical user interface or a web browser through which a user can interact with an implementation of the subject matter described herein, or any combination of one or more such back-end, middleware, or front-end components. The components of the system can be interconnected by any form or medium of digital information/data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some embodiments, a server transmits information/data (e.g., an HTML page) to a client device (e.g., for purposes of displaying information/data to and receiving user input from a user interacting with the client device). Information/data generated at the client device (e.g., a result of the user interaction) can be received from the client device at the server.

While this specification contains many specific implementation details, these should not be construed as limitations on the scope of any disclosures or of what may be claimed, but rather as descriptions of features specific to particular embodiments of particular disclosures. Certain features that are described herein in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

What is claimed is:

1. A computer-implemented method comprising:
identifying, by one or more processors, a plurality of model operations associated with a plurality of assets;
generating, by the one or more processors, a plurality of model dependency graphs by applying the plurality of model operations to a graph machine learning model, wherein each model dependency graph comprises a unique subset of the plurality of model operations having a dependency relationship and defines a processing sequence;
generating, by the one or more processors, one or more asset clusters by applying the plurality of model dependency graphs to a clustering machine learning model,
generating, by the one or more processors and based on one or more grouping parameters, one or more processing groups each comprising at least one asset cluster of the one or more asset clusters; and
assigning, by the one or more processors, each of the one or more processing groups to a different processing sub stream of a plurality of processing sub streams such that each processing sub stream is associated with a processing group of the one or more processing groups to facilitate parallel processing.

2. The computer-implemented method of claim 1, further comprising:
receiving telemetry data messages associated with the plurality of assets; and
routing each of the telemetry data messages to a corresponding processing sub stream of the plurality of processing sub streams based on the processing group associated with each of the telemetry data messages.

3. The computer-implemented method of claim 2, further comprising:
processing the plurality of processing sub streams in response to the telemetry data messages routed to each of the plurality of processing sub streams, wherein at least a subset of the plurality of processing sub streams are processed in parallel.

4. The computer-implemented method of claim 3, wherein processing the plurality of processing sub streams comprises:
processing by a first processor worker of a processor worker set, a first set of telemetry data messages in a first processing sub stream of the plurality of processing sub streams; and
processing, by a second processor worker of the processor worker set, a second set of telemetry data messages in a second processing sub stream of the plurality of processing sub streams.

5. The computer-implemented method of claim 4, wherein processing the first set of telemetry data messages comprises:
identifying a first model dependency graph associated with the first processing sub stream; and
executing the unique subset of the plurality of model operations in the first model dependency graph in a sequential order based on the processing sequence defined by the first model dependency graph to generate one or more outputs, wherein executing the unique subset of the plurality of model operations in the first model dependency graph comprises applying telemetry data associated with the first set of telemetry data messages to the plurality of model operations.

6. The computer-implemented method of claim 5, further comprising:
initiating performance of one or more asset monitoring and control implementation actions responsive to the one or more outputs being generated.

7. The computer-implemented method of claim 1, wherein the one or more grouping parameters comprises one or more of backfill latency threshold, expected execution frequency, site-specific model operation count, or worker model operation count.

8. The computer-implemented method of claim 1, wherein generating the one or more processing groups comprises:
determining a maximum number of model operations for each processing sub stream based on the one or more grouping parameters; and
performing iterative processing group assignment such that each processing group has a size does not exceed the maximum number of model operations.

9. The computer-implemented method of claim 1, wherein each processing sub stream is associated with a resource consumption throttling mechanism.

10. An apparatus comprising memory and one or more processors communicatively coupled to the memory, the one or more processors configured to:
identify a plurality of model operations associated with a plurality of assets;
generate a plurality of model dependency graphs by applying the plurality of model operations to a graph machine learning model, wherein each model dependency graph comprises a unique subset of the plurality of model operations having a dependency relationship and defines a processing sequence;
generate one or more asset clusters by applying the plurality of model dependency graphs to a clustering machine learning model,
generating, based on one or more grouping parameters, one or more processing groups each comprising at least one asset cluster of the one or more asset clusters; and
assign each of the one or more processing groups to different processing sub streams of a plurality of processing sub streams such that each processing sub stream is associated with a processing group of the one or more processing groups to facilitate parallel processing.

11. The apparatus of claim 10, wherein the one or more processors are further configured to:
receive telemetry data messages associated with the plurality of assets; and
route each of the telemetry data messages to a corresponding processing sub stream of the plurality of processing sub streams based on the processing group associated with each of the telemetry data messages.

12. The apparatus of claim 11, wherein the one or more processors are further configured to:
process the plurality of processing sub streams in response to the telemetry data messages routed to each of the plurality of processing sub streams, wherein at least a subset of the plurality of processing sub streams are processed in parallel.

13. The apparatus of claim 12, wherein the one or more processors are configured to process the plurality of processing sub streams by:
processing by a first processor worker of a processor worker set, a first set of telemetry data messages in a first processing sub stream of the plurality of processing sub streams; and
processing, by a second processor worker of the processor worker set, a second set of telemetry data messages in a second processing sub stream of the plurality of processing sub streams.

14. The apparatus of claim 13, wherein the one or more processors are configured to process the plurality of processing sub streams by:
identifying a first model dependency graph associated with the first processing sub stream; and
executing the unique subset of the plurality of model operations in the first model dependency graph in a sequential order based on the processing sequence defined by the first model dependency graph to generate one or more outputs, wherein executing the unique subset of the plurality of model operations in the first model dependency graph comprises applying telemetry data associated with the first set of telemetry data messages to the plurality of model operations.

15. The apparatus of claim 14, wherein the one or more processors are further configured to:
initiate performance of one or more asset monitoring and control implementation actions responsive to the one or more outputs being generated.

16. The apparatus of claim 10, wherein the one or more grouping parameters comprises one or more of backfill latency threshold, expected execution frequency, site-specific model operation count, or worker model operation count.

17. The apparatus of claim 10, wherein the one or more processors are configured to generate the one or more processing groups by:
determining a maximum number of model operations for each processing sub stream based on the one or more grouping parameters; and
performing iterative processing group assignment such that each processing group as a size that does not exceed the maximum number of model operations.

18. The apparatus of claim 10, wherein each processing sub stream is associated with a resource consumption throttling mechanism.

19. At least one non-transitory computer-readable storage medium having computer coded instructions configured to, when executed by at least one processor:
identify a plurality of model operations associated with a plurality of assets;
generate a plurality of model dependency graphs by applying the plurality of model operations to a graph machine learning model, wherein each model dependency graph comprises a unique subset of the plurality of model operations having a dependency relationship and defines a processing sequence;
generate one or more asset clusters by applying the plurality of model dependency graphs to a clustering machine learning model,
generating, based on one or more grouping parameters, one or more processing groups each comprising at least one asset cluster of the one or more asset clusters; and
assign each of the one or more processing groups to different processing sub streams of a plurality of processing sub streams such that each processing sub stream is associated with a processing group of the one or more processing groups to facilitate parallel processing.

20. The at least one non-transitory computer-readable storage medium of claim 19, wherein the computer coded instructions further configured to, when executed by the at least one processor:
receive telemetry data messages associated with the plurality of assets; and
route each of the telemetry data messages to a corresponding processing sub stream of the plurality of processing sub streams based on the processing group associated with each of the telemetry data messages.
